(19) United States
(12) Patent Application Publication
(10) Pub. No.: US 2021/0039676 A1
(43) Pub. Date: Feb. 11, 2021

(54) PATH PROVIDING DEVICE AND PATH PROVIDING METHOD THEREOF

(71) Applicant: LG Electronics Inc., Seoul (KR)

(72) Inventors: Jinsang LEE, Seoul (KR); Jihyun KIM, Seoul (KR)

(21) Appl. No.: 17/036,728

(22) Filed: Sep. 29, 2020

Related U.S. Application Data
(63) Continuation of application No. PCT/KR2019/009974, filed on Aug. 8, 2019.

(51) Int. Cl. B60W 60/00; G06K 9/00; G01C 21/32

(52) U.S. Cl. CPC B60W 60/0021; G01C 21/32; G06K 9/00798

(57) ABSTRACT

A path providing device is configured to provide path information to a vehicle. The path providing device includes a memory configured to store information used for estimating or updating an optimal path, and the memory includes a plurality of memories configured to store the information used for estimating or updating the optimal path in different storage spaces based on types of information to be stored.

### CROSS-REFERENCE TO RELATED APPLICATION

This application is a continuation of International Application No. PCT/KR2019/009974, filed on Aug. 8, 2019, the disclosure of which is incorporated by reference in its entirety.

### TECHNICAL FIELD

The present disclosure relates to a path providing device for providing a path to a vehicle and a path providing method thereof.

### BACKGROUND

A vehicle may transport people or goods by using kinetic energy. Representative examples of vehicles include automobiles and motorcycles.

In some cases, for safety and convenience of a user who uses the vehicle, various sensors and devices may be provided in the vehicle, and functions of the vehicle may be diversified.

The functions of the vehicle may be divided into a convenience function for promoting driver's convenience, and a safety function for enhancing safety of the driver and/or pedestrians.

The convenience function may provide the driver's convenience, for example, by providing infotainment (information+entertainment) to the vehicle, supporting a partially autonomous driving function, or helping the driver ensuring a field of vision at night or at a blind spot. In some examples, the convenience functions may include various functions, such as an active cruise control (ACC), a smart parking assist system (SPAS), a night vision (NV), a head up display (HUD), an around view monitor (AVM), an adaptive headlight system (AHS), and the like.

The safety function may include a technique of ensuring safeties of the driver and/or pedestrians, and various functions, such as a lane departure warning system (LDWS), a lane keeping assist system (LKAS), an autonomous emergency braking (AEB), and the like. For convenience of a user using a vehicle, various types of sensors and electronic devices may be provided in the vehicle. For example, a vehicle may include an Advanced Driver Assistance System (ADAS). In some cases, a vehicle may be an autonomous vehicle.

The advanced driver assistance system (ADAS) may be improved by a technology for optimizing user's convenience and safety while driving a vehicle.

For example, in order to effectively transmit electronic Horizon (eHorizon) data to autonomous driving systems and infotainment systems, the European Union Original Equipment Manufacturing (EU OEM) Association has established a data specification and transmission method as a standard under the name “Advanced Driver Assistance Systems Interface Specification (ADASIS).”

In some cases, eHorizon software may be an integral part of safety/ECO/convenience of autonomous vehicles in a connected environment.

### SUMMARY

The present disclosure describes a path providing device capable of providing autonomous driving visibility information enabling autonomous driving, and a path providing method thereof.

The present disclosure also describes a path providing device having a memory in which information for generating or updating autonomous driving visibility information is stored in an optimized manner, and a path providing method thereof.

According to one aspect of the subject matter described in this application, a path providing device is configured to provide path information to a vehicle. The device includes a processor, a communication unit configured to receive map information from a server, where the map information includes a plurality of layers of data, and an interface unit configured to receive sensing information from one or more sensors disposed at the vehicle, the sensing information comprising an image received from an image sensor. The processor is configured to, based on the sensing information, identify a lane in which the vehicle is located among a plurality of lanes of a road, determine an optimal path for guiding the vehicle from the identified lane, where the optimal path includes one or more lanes included in the map information, based on the sensing information and the optimal path, generate autonomous driving visibility information to be transmitted to at least one of an electric component disposed at the vehicle or the server, and update the optimal path based on the autonomous driving visibility information and dynamic information related to a movable object located in the optimal path. The path providing device further includes a memory configured to store information used for determining or updating the optimal path, where the memory includes a plurality of memories configured to store the information used for determining or updating the optimal path in different storage spaces based on types of information to be stored.

Implementations according to this aspect may include one or more of the following features. For example, the plurality of memories may include a first memory configured to store first data based on power being supplied to the first memory, and a second memory configured to retain second data while power is not supplied to the second memory. In some implementations, the path providing device may further include a data bus that is connected to the first memory to and the second memory and configured to transmit the map information received through the communication unit to at least one of the first memory or the second memory. In some implementations, the path providing device may further include one or more interfaces that connect the data bus to the first memory and the second memory.

In some examples, the second memory has a first processing speed and a first storage capacity, and the data bus may be connected, through the one or more interfaces, to an external storage having a second processing speed slower than the first processing speed and a second storage capacity greater than the first storage capacity.

In some implementations, the second memory may be divided into a plurality of storage spaces that are configured to store different types of data, each of the plurality of storage spaces being configured to store one of the plurality of layers. In some examples, the plurality of storage spaces of the second memory may include a first storage space configured to store a first type of data corresponding to a first layer among the plurality of layers, and a second storage space configured to store a second type of data corresponding to a second layer among the plurality of layers, where the second layer is different from the first layer.

In some implementations, each of the first memory and the second memory may be configured to perform bidirectional data communication with the communication unit through the data bus. In some implementations, the plurality of layers comprise at least one of a first layer including topology data, a second layer including advanced driver-assistance systems (ADAS) data, a third layer including high-density (HD) map data, or a fourth layer including the dynamic information.

In some implementations, the memory may be further configured to store program instructions to be performed by the processor for determining or updating the optimal path.

According to another aspect, a non-transitory memory device has stored thereon program instructions which, when executed by at least one processor, cause performance of operations for providing path information to a vehicle. The operations include receiving map information from a server, the map information comprising a plurality of layers of data, receiving, through a communication unit, sensing information from one or more sensors disposed at the vehicle, where the sensing information includes an image received from an image sensor, based on the sensing information, identifying a lane in which the vehicle is located among a plurality of lanes of a road, determining an optimal path for guiding the vehicle from the identified lane, where the optimal path includes one or more lanes included in the map information, based on the sensing information and the optimal path, generating autonomous driving visibility information to be transmitted to at least one of an electric component disposed at the vehicle or the server, and updating the optimal path based on the autonomous driving visibility information and dynamic information related to a movable object located in the optimal path.

Implementations according to this aspect may include one or more of the following features or the features described above for the path providing device. For example, the non-transitory memory device may include a plurality of memories configured to store information used for determining or updating the optimal path in different storage spaces based on types of information to be stored. In some implementations, the plurality of memories may include a first memory configured to store first data based on power being supplied to the first memory, and a second memory configured to retain second data while power is not supplied to the second memory.

In some implementations, the first memory and the second memory may be connected to a data bus configured to transmit the map information received through the communication unit to at least one of the first memory or the second memory. In some examples, the second memory has a first processing speed and a first storage capacity, and the data bus may be connected to an external storage having a second processing speed slower than the first processing speed and a second storage capacity greater than the first storage capacity.

In some implementations, the second memory may be divided into a plurality of storage spaces that are configured to store different types of data, where each of the plurality of storage spaces may be configured to store one of the plurality of layers. In some examples, the plurality of storage spaces of the second memory may include a first storage space configured to store a first type of data corresponding to a first layer among the plurality of layers, and a second storage space configured to store a second type of data corresponding to a second layer among the plurality of layers, where the second layer is different from the first layer.

In some implementations, the operations may further include performing bidirectional data communication between the communication unit and each of the first memory and the second memory through the data bus. In some implementations, the plurality of layers may include at least one of a first layer including topology data, a second layer including advanced driver-assistance systems (ADAS) data, a third layer including high-density (HD) map data, or a fourth layer including the dynamic information.

In some implementations, the first memory may include a random access memory (RAM), and the second memory may include a flash memory device.

In some implementations, the processor may store a plurality of map information made by different map information providers in the divided plurality of storage spaces, separately, when the plurality of map information is received.

In some implementations, the processor may store first map information received from a first map information provider in a first storage space among the plurality of storage spaces, and store second map information received from a second map information provider in a second storage space among the plurality of storage spaces.

In some implementations, the processor may determine storage spaces for storing the plurality of map information based on respective capacities of the received plurality of map information.

In some implementations, the processor may divide a driving road to a destination into a plurality of path sections based on road characteristics, and determine a type of map information to be used for each of the divided path sections based on the road characteristic.

In some implementations, the processor may generate an optimal path using first map information associated with a first characteristic for a path section having the first characteristic, and generate an optimal path using second map information associated with a second characteristic, different from the first characteristic, for a path section having the second characteristic.

In some implementations, the first map information and the second map information may be different map information received from different map information providers.

In some implementations, the first map information and the second map information may be partial map information that has a predetermined size or less and includes the divided path sections.

In some implementations, the processor may determine a path section including a current location of the vehicle among the divided path sections, determine map information in the memory based on a road characteristic of the determined path section, and estimates an optimal path in lane units in the determined path section by using the determined map information.

In some implementations, the memory may include a first memory configured to temporarily store data while power is supplied, and a second memory configured to store data even when power is cut off.

In some implementations, the plurality of map information may be stored in the second memory. The processor may divide a driving road to a destination into a plurality of path sections based on road characteristics, and determine map information to be used for each of the divided path sections based on the road characteristics, and generate an optimal path in each path section by loading map information to be used for each path section from the second memory into the first memory.

In some implementations, the processor may delete the loaded map information when the vehicle has passed through a path section in which the map information loaded to the first memory is used.

In some implementations, the processor may preferentially store information received through the communication unit in the first memory, and delete the information from the first memory or move the information to the second memory for storage based on a type of the information stored in the first memory.

In some implementations, when information received through the communication unit is map information having a predetermined capacity or more, the processor may store the map information having the predetermined capacity or more in an external storage that is provided in the vehicle and located outside the path providing device.

In some implementations, the second memory may be divided into a plurality of storage spaces, and the plurality of layers of the map information may be separately stored in the plurality of storage spaces, respectively.

In some implementations, the processor may determine a type of a memory in which each layer is stored and a storage space in the second memory based on at least one of a type and a capacity of each of the plurality of layers.

In some implementations, the path providing device may include a memory optimized for generating or updating autonomous driving visibility information.

In some implementations, the optimized memory may effectively store and delete information necessary to perform autonomous driving or lane-based path guidance.

In some implementations, the path providing device may efficiently process received information using a plurality of memories, and improve memory efficiency by storing or deleting information according to a type of information.

In some implementations, the path providing device may store different types of map information generated in different map providers separately by dividing a memory into a plurality of storage spaces, and may generate autonomous driving visibility information or an optimal path by loading optimized map information from the memory according to situations.

### BRIEF DESCRIPTION OF THE DRAWINGS

FIG. 1 is a view illustrating an appearance of an example vehicle.

FIG. 2 is a diagram illustrating the vehicle at various angles.

FIGS. 3 and 4 are diagrams illustrating an inside of an example vehicle.

FIGS. 5 and 6 are diagrams illustrating example objects.

FIG. 7 is a block diagram illustrating example components of an example vehicle.

FIG. 8 is a diagram illustrating an example of Electronic Horizon Provider (EHP).

FIG. 9 is a block diagram illustrating an example of a path providing device (e.g., the EHP of FIG. 8).

FIG. 10 is a diagram illustrating an example of eHorizon.

FIGS. 11A and 11B are diagrams illustrating examples of a Local Dynamic Map (LDM) and an Advanced Driver Assistance System (ADAS) MAP.

FIGS. 12A and 12B are diagrams illustrating examples of receiving high-definition map data by a path providing device.

FIG. 13 is a flowchart illustrating an example of a method for generating autonomous driving visibility information based on receiving high-definition map by the path providing device.

FIG. 14 is a conceptual view illustrating an example of a memory included in the path providing device.

FIGS. 15A and 15B are conceptual views illustrating an example of a method for storing data received in a path providing device into a memory.

FIG. 16 is a conceptual view illustrating an example of a memory having a plurality of storage spaces.

FIGS. 17, 18, and 19 are conceptual views illustrating example methods for controlling a memory.

FIGS. 20 and 21 are conceptual views illustrating an example of storing map information in a memory.

FIGS. 22, 23, and 24 are conceptual views illustrating example methods for controlling a memory.

FIGS. 25 and 26 are diagrams illustrating an example method for generating an optimal path (route) using map information stored in a memory.

### DETAILED DESCRIPTION

Description will now be given in detail according to one or more implementations disclosed herein, with reference to the accompanying drawings. For the sake of brief description with reference to the drawings, the same or equivalent components may be provided with the same or similar reference numbers, and description thereof will not be repeated.

A vehicle include various types of automobiles such as cars, motorcycles and the like. Hereinafter, the vehicle will be described based on a car.

The vehicle may include any of an internal combustion engine car having an engine as a power source, a hybrid vehicle having an engine and an electric motor as power sources, an electric vehicle having an electric motor as a power source, and the like.

In the following description, a left side of a vehicle refers to a left side in a driving direction of the vehicle, and a right side of the vehicle refers to a right side in the driving direction.

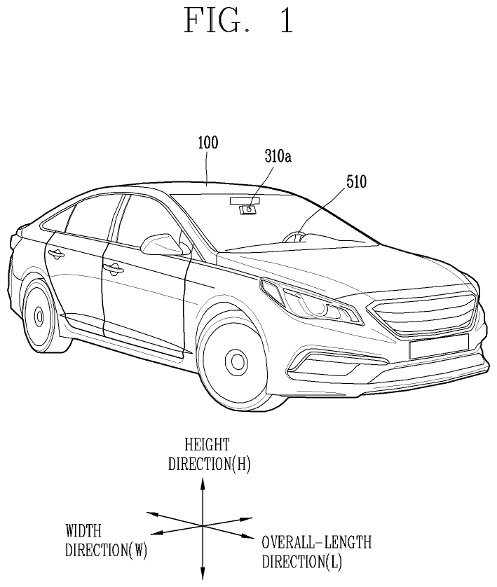

FIG. 1 is a view illustrating an appearance of an example vehicle.

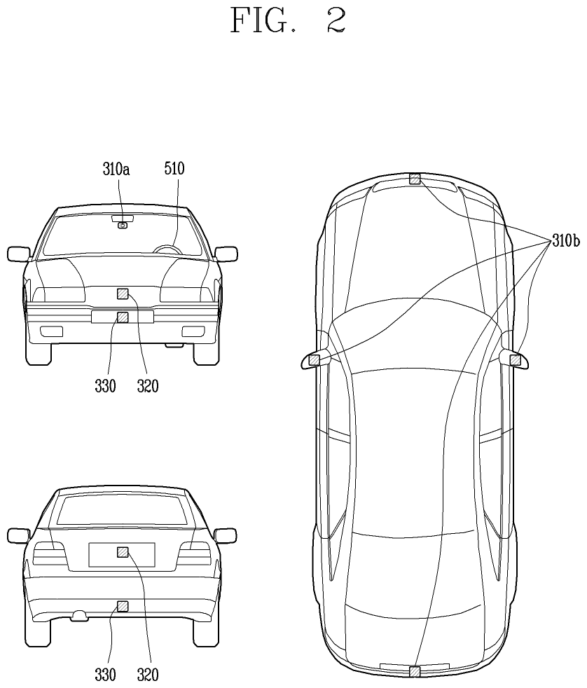

FIG. 2 is a diagram illustrating the vehicle at various angles.

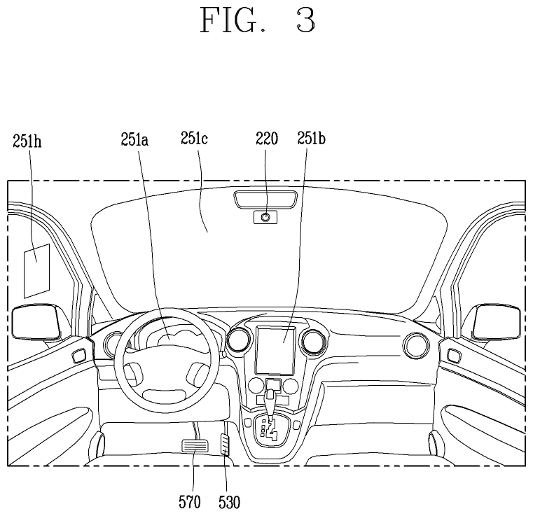

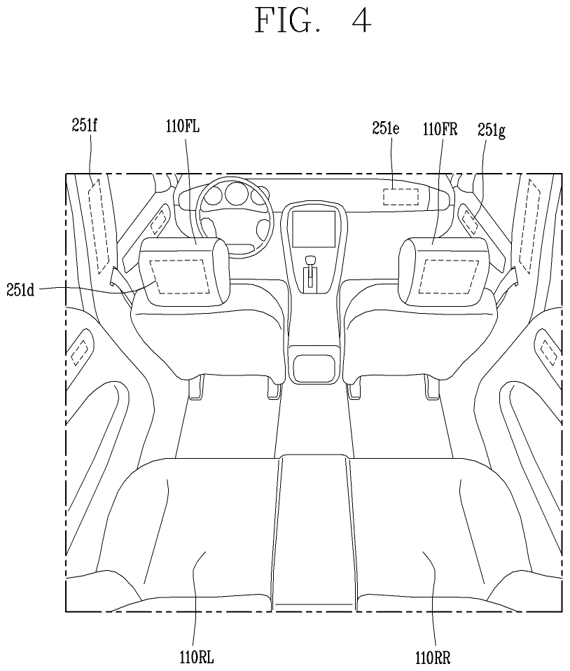

FIGS. 3 and 4 are diagrams illustrating an inside of an example vehicle.

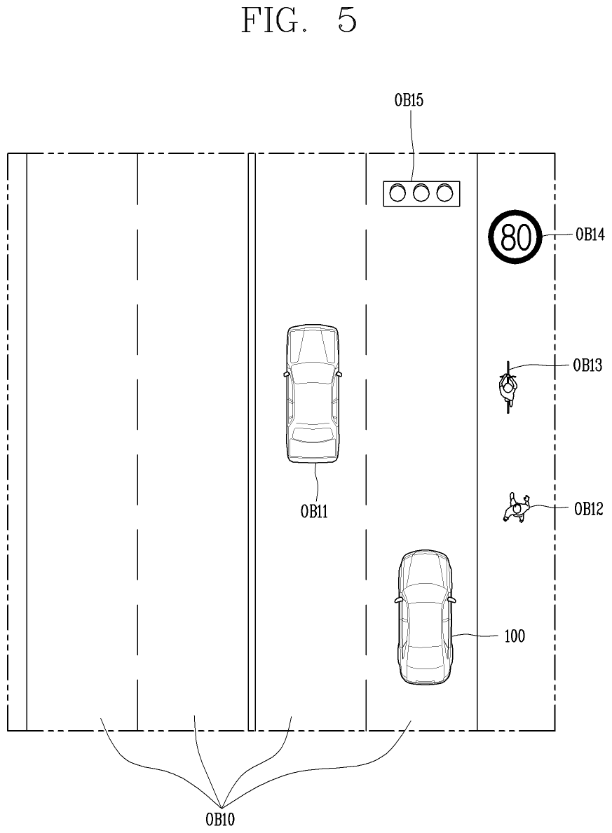

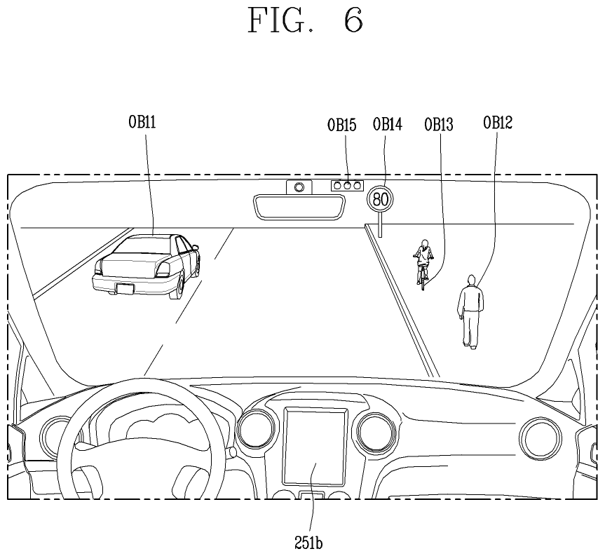

FIGS. 5 and 6 are diagrams illustrating example objects.

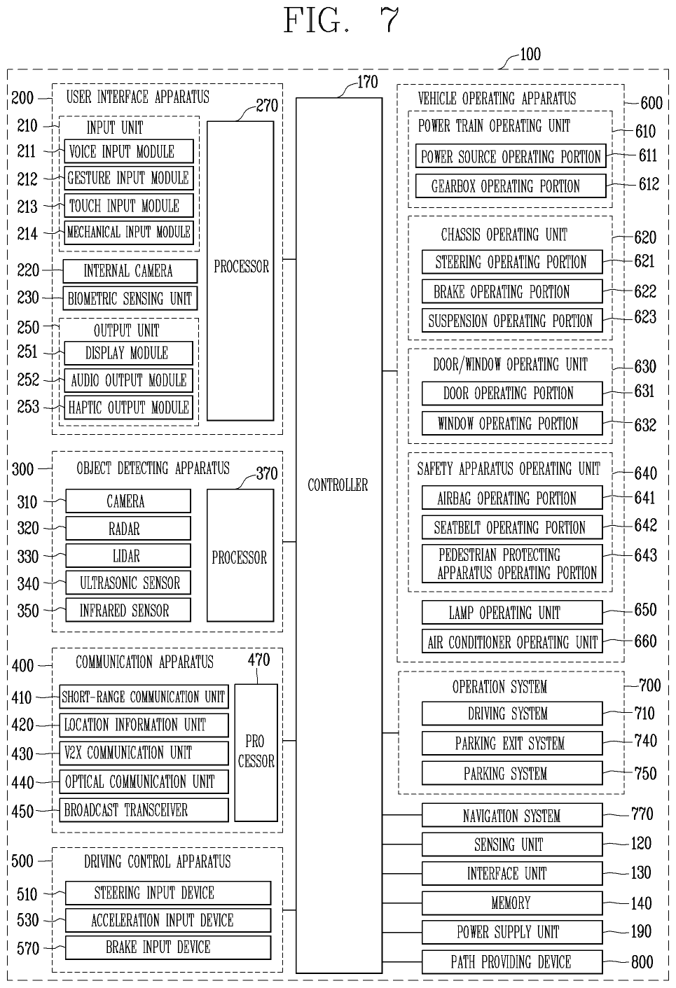

FIG. 7 is a block diagram illustrating example components of an example vehicle.

As illustrated in FIGS. 1 to 7, a vehicle 100 may include wheels turning by a driving force, and a steering input device 510 for adjusting a driving (ongoing, moving) direction of the vehicle 100.

The vehicle 100 may be an autonomous vehicle.

The vehicle 100 may be switched into an autonomous mode or a manual mode based on a user input.

For example, the vehicle may be converted from the manual mode into the autonomous mode or from the autonomous mode into the manual mode based on a user input received through a user interface apparatus 200.

The vehicle 100 may be switched into the autonomous mode or the manual mode based on driving environment information. The driving environment information may be generated based on object information provided from an object detecting apparatus 300.

For example, the vehicle 100 may be switched from the manual mode into the autonomous mode or from the autonomous module into the manual mode based on driving environment information generated in the object detecting apparatus 300.

In an example, the vehicle 100 may be switched from the manual mode into the autonomous mode or from the autonomous module into the manual mode based on driving environment information received through a communication apparatus 400.

The vehicle 100 may be switched from the manual mode into the autonomous mode or from the autonomous module into the manual mode based on information, data or signal provided from an external device.

When the vehicle 100 is driven in the autonomous mode, the autonomous vehicle 100 may be driven based on an operation system 700.

For example, the autonomous vehicle 100 may be driven based on information, data or signal generated in a driving system 710, a parking exit system 740 and a parking system 750.

When the vehicle 100 is driven in the manual mode, the autonomous vehicle 100 may receive a user input for driving through a driving control apparatus 500. The vehicle 100 may be driven based on the user input received through the driving control apparatus 500.

An overall length refers to a length from a front end to a rear end of the vehicle 100, a width refers to a width of the vehicle 100, and a height refers to a length from a bottom of a wheel to a roof. In the following description, an overall-length direction L may refer to a direction which is a criterion for measuring the overall length of the vehicle 100, a width direction W may refer to a direction that is a criterion for measuring a width of the vehicle 100, and a height direction H may refer to a direction that is a criterion for measuring a height of the vehicle 100.

As illustrated in FIG. 7, the vehicle 100 may include a user interface apparatus 200, an object detecting apparatus 300, a communication apparatus 400, a driving control apparatus 500, a vehicle operating apparatus 600, an operation system 700, a navigation system 770, a sensing unit 120, an interface unit 130, a memory 140, a controller 170 and a power supply unit 190.

In some implementations, the vehicle 100 may include more components in addition to components to be explained in this specification or may not include some of those components to be explained in this specification.

The user interface apparatus 200 is an apparatus for communication between the vehicle 100 and a user. The user interface apparatus 200 may receive a user input and provide information generated in the vehicle 100 to the user. The vehicle 100 may implement user interfaces (UIs) or user experiences (UXs) through the user interface apparatus 200.

The user interface apparatus 200 may include an input unit 210, an internal camera 220, a biometric sensing unit 230, an output unit 250 and at least one processor, such as processor 270.

In some implementations, the user interface apparatus 200 may include more components in addition to components to be explained in this specification or may not include some of those components to be explained in this specification.

The input unit 210 may allow the user to input information. Data collected in the input unit 210 may be analyzed by the processor 270 and processed as a user's control command.

The input unit 210 may be disposed inside the vehicle. For example, the input unit 210 may be disposed on one area of a steering wheel, one area of an instrument panel, one area of a seat, one area of each pillar, one area of a door, one area of a center console, one area of a headlining, one area of a sun visor, one area of a wind shield, one area of a window or the like.

The input unit 210 may include an audio input module 211, a gesture input module 212, a touch input module 213, and a mechanical input module 214.

The audio input module 211 may convert a user's voice input into an electric signal. The converted electric signal may be provided to the processor 270 or the controller 170.

The audio input module 211 may include at least one microphone.

The gesture input module 212 may convert a user's gesture input into an electric signal. The converted electric signal may be provided to the processor 270 or the controller 170.

The gesture input module 212 may include at least one of an infrared sensor and an image sensor for detecting the user's gesture input.

In some implementations, the gesture input module 212 may detect a user's three-dimensional (3D) gesture input. To this end, the gesture input module 212 may include a light emitting diode outputting a plurality of infrared rays or a plurality of image sensors.

The gesture input module 212 may detect the user's 3D gesture input by a time of flight (TOF) method, a structured light method or a disparity method.

The touch input module 213 may convert the user's touch input into an electric signal. The converted electric signal may be provided to the processor 270 or the controller 170.

The touch input module 213 may include a touch sensor for detecting the user's touch input.

In some implementations, the touch input module 213 may be integrated with the display module 251 so as to implement a touch screen. The touch screen may provide an input interface and an output interface between the vehicle 100 and the user.

The mechanical input module 214 may include at least one of a button, a dome switch, a jog wheel and a jog switch. An electric signal generated by the mechanical input module 214 may be provided to the processor 270 or the controller 170.

The mechanical input module 214 may be arranged on a steering wheel, a center fascia, a center console, a cockpit module, a door and the like.

The internal camera 220 may acquire an internal image of the vehicle. The processor 270 may detect a user's state based on the internal image of the vehicle. The processor 270 may acquire information related to the user's gaze from the internal image of the vehicle. The processor 270 may detect a user gesture from the internal image of the vehicle.

The biometric sensing unit 230 may acquire the user's biometric information. The biometric sensing unit 230 may include a sensor for detecting the user's biometric information and acquire fingerprint information and heart rate information regarding the user using the sensor. The biometric information may be used for user authentication.

The output unit 250 may generate an output related to a visual, audible or tactile signal.

The output unit 250 may include at least one of a display module 251, an audio output module 252 and a haptic output module 253.

The display module 251 may output graphic objects corresponding to various types of information.

The display module 251 may include at least one of a liquid crystal display (LCD), a thin film transistor-LCD (TFT LCD), an organic light-emitting diode (OLED), a flexible display, a three-dimensional (3D) display and an e-ink display.

The display module 251 may be inter-layered or integrated with a touch input module 213 to implement a touch screen.

The display module 251 may be implemented as a head up display (HUD). When the display module 251 is implemented as the HUD, the display module 251 may be provided with a projecting module so as to output information through an image which is projected on a windshield or a window.

The display module 251 may include a transparent display. The transparent display may be attached to the windshield or the window.

The transparent display may have a predetermined degree of transparency and output a predetermined screen thereon. The transparent display may include at least one of a thin film electroluminescent (TFEL), a transparent OLED, a transparent LCD, a transmissive transparent display and a transparent LED display. The transparent display may have adjustable transparency.

In some examples, the user interface apparatus 200 may include a plurality of display modules 251a to 251g.

The display module 251 may be disposed on one area of a steering wheel, one area 521a, 251b, 251e of an instrument panel, one area 251d of a seat, one area 251f of each pillar, one area 251g of a door, one area of a center console, one area of a headlining or one area of a sun visor, or implemented on one area 251c of a windshield or one area 251h of a window.

The audio output module 252 converts an electric signal provided from the processor 270 or the controller 170 into an audio signal for output. To this end, the audio output module 252 may include at least one speaker.

The haptic output module 253 generates a tactile output. For example, the haptic output module 253 may vibrate the steering wheel, a safety belt, a seat 110FL, 110FR, 110RL, 110RR such that the user may recognize such output.

The processor 270 may control an overall operation of each unit of the user interface apparatus 200.

In some implementations, the user interface apparatus 200 may include a plurality of processors 270 or may not include any processor 270.

When the processor 270 is not included in the user interface apparatus 200, the user interface apparatus 200 may operate according to a control of a processor of another apparatus within the vehicle 100 or the controller 170.

In some examples, the user interface apparatus 200 may be called as a display apparatus for vehicle.

The user interface apparatus 200 may operate according to the control of the controller 170.

The object detecting apparatus 300 is an apparatus for detecting an object located at outside of the vehicle 100.

The object may be a variety of objects associated with driving (operation) of the vehicle 100.

Referring to FIGS. 5 and 6, an object O may include a traffic lane OB10, another vehicle OB11, a pedestrian OB12, a two-wheeled vehicle OB13, traffic signals OB14 and OB15, light, a road, a structure, a speed hump, a terrain, an animal and the like.

The lane OB01 may be a driving lane, a lane next to the driving lane or a lane on which another vehicle comes in an opposite direction to the vehicle 100. The lanes OB10 may include left and right lines forming a lane.

The another vehicle OB11 may be a vehicle which is moving around the vehicle 100. The another vehicle OB11 may be a vehicle located within a predetermined distance from the vehicle 100. For example, the another vehicle OB11 may be a vehicle which moves before or after the vehicle 100. In some examples, the vehicle 100 may be a first vehicle, and the vehicle OB11 may be a second vehicle.

The pedestrian OB12 may be a person located near the vehicle 100. The pedestrian OB12 may be a person located within a predetermined distance from the vehicle 100. For example, the pedestrian OB12 may be a person located on a sidewalk or roadway.

The two-wheeled vehicle OB12 may refer to a vehicle (transportation facility) that is located near the vehicle 100 and moves using two wheels. The two-wheeled vehicle OB12 may be a vehicle that is located within a predetermined distance from the vehicle 100 and has two wheels. For example, the two-wheeled vehicle OB13 may be a motorcycle or a bicycle that is located on a sidewalk or roadway.

The traffic signals may include a traffic light OB15, a traffic sign OB14 and a pattern or text drawn on a road surface.

The light may be light emitted from a lamp provided on another vehicle. The light may be light generated from a streetlamp. The light may be solar light.

The road may include a road surface, a curve, an upward slope, a downward slope and the like.

The structure may be an object that is located near a road and fixed on the ground. For example, the structure may include a streetlamp, a roadside tree, a building, an electric pole, a traffic light, a bridge and the like.

The terrain may include a mountain, a hill and the like.

In some examples, objects may be classified into a moving object and a fixed object. For example, the moving object may include another vehicle or a pedestrian. The fixed object may be, for example, a traffic signal, a road, or a structure.

The object detecting apparatus 300 may include a camera 310, a radar 320, a LiDAR 330, an ultrasonic sensor 340, an infrared sensor 350 and at least one processor, such as processor 370.

In some implementations, the object detecting apparatus 300 may further include other components in addition to the components described, or may not include some of the components described.

The camera 310 may be located on an appropriate portion outside the vehicle to acquire an external image of the vehicle. The camera 310 may be a mono camera, a stereo camera 310a, an around view monitoring (AVM) camera 310b or a 360-degree camera.

For example, the camera 310 may be disposed adjacent to a front windshield within the vehicle to acquire a front image of the vehicle. Or, the camera 310 may be disposed adjacent to a front bumper or a radiator grill.

For example, the camera 310 may be disposed adjacent to a rear glass within the vehicle to acquire a rear image of the vehicle. Or, the camera 310 may be disposed adjacent to a rear bumper, a trunk or a tail gate.

For example, the camera 310 may be disposed adjacent to at least one of side windows within the vehicle to acquire a side image of the vehicle. Or, the camera 310 may be disposed adjacent to a side mirror, a fender or a door.

The camera 310 may provide an acquired image to the processor 370.

The radar 320 may include electric wave transmitting and receiving portions. The radar 320 may be implemented as a pulse radar or a continuous wave radar according to a principle of emitting electric waves. The radar 320 may be implemented in a frequency modulated continuous wave (FMCW) manner or a Frequency Shift Keying (FSK) manner according to a signal waveform, among the continuous wave radar methods.

The radar 320 may detect an object in a time of flight (TOF) manner or a phase-shift manner through the medium of the electric wave, and detect a position (or location) of the detected object, a distance from the detected object and a relative speed with the detected object.

The radar 320 may be disposed on an appropriate position outside the vehicle for detecting an object which is located at a front, rear or side of the vehicle.

The LiDAR 330 may include laser transmitting and receiving portions. The LiDAR 330 may be implemented in a time of flight (TOF) manner or a phase-shift manner.

The LiDAR 330 may be implemented as a drive type or a non-drive type.

For the drive type, the LiDAR 330 may be rotated by a motor and detect object near the vehicle 100.

For the non-drive type, the LiDAR 330 may detect, through light steering, objects which are located within a predetermined range based on the vehicle 100. The vehicle 100 may include a plurality of non-drive type LiDARs 330.

The LiDAR 330 may detect an object in a TOP manner or a phase-shift manner through the medium of a laser beam, and detect a position of the detected object, a distance from the detected object and a relative speed with the detected object.

The LiDAR 330 may be disposed on an appropriate position outside the vehicle for detecting an object located at the front, rear or side of the vehicle.

The ultrasonic sensor 340 may include ultrasonic wave transmitting and receiving portions. The ultrasonic sensor 340 may detect an object based on an ultrasonic wave, and detect a position of the detected object, a distance from the detected object and a relative speed with the detected object.

The ultrasonic sensor 340 may be disposed on an appropriate position outside the vehicle for detecting an object located at the front, rear or side of the vehicle.

The infrared sensor 350 may include infrared light transmitting and receiving portions. The infrared sensor 350 may detect an object based on infrared light, and detect a position of the detected object, a distance from the detected object and a relative speed with the detected object.

The infrared sensor 350 may be disposed on an appropriate position outside the vehicle for detecting an object located at the front, rear or side of the vehicle.

The processor 370 may control an overall operation of each unit of the object detecting apparatus 300.

The processor 370 may detect an object based on an acquired image, and track the object. The processor 370 may execute operations, such as a calculation of a distance from the object, a calculation of a relative speed with the object and the like, through an image processing algorithm.

The processor 370 may detect an object based on a reflected electromagnetic wave which an emitted electromagnetic wave is reflected from the object, and track the object. The processor 370 may execute operations, such as a calculation of a distance from the object, a calculation of a relative speed with the object and the like, based on the electromagnetic wave.

The processor 370 may detect an object based on a reflected laser beam which an emitted laser beam is reflected from the object, and track the object. The processor 370 may execute operations, such as a calculation of a distance from the object, a calculation of a relative speed with the object and the like, based on the laser beam.

The processor 370 may detect an object based on a reflected ultrasonic wave which an emitted ultrasonic wave is reflected from the object, and track the object. The processor 370 may execute operations, such as a calculation of a distance from the object, a calculation of a relative speed with the object and the like, based on the ultrasonic wave.

The processor may detect an object based on reflected infrared light which emitted infrared light is reflected from the object, and track the object. The processor 370 may execute operations, such as a calculation of a distance from the object, a calculation of a relative speed with the object and the like, based on the infrared light.

In some implementations, the object detecting apparatus 300 may include a plurality of processors 370 or may not include any processor 370. For example, each of the camera 310, the radar 320, the LiDAR 330, the ultrasonic sensor 340 and the infrared sensor 350 may include the processor in an individual manner.

When the processor 370 is not included in the object detecting apparatus 300, the object detecting apparatus 300 may operate according to the control of a processor of an apparatus within the vehicle 100 or the controller 170.

The object detecting apparatus 300 may operate according to the control of the controller 170.

The communication apparatus 400 is an apparatus for performing communication with an external device. Here, the external device may be another vehicle, a mobile terminal or a server.

The communication apparatus 400 may perform the communication by including at least one of a transmitting antenna, a receiving antenna, and radio frequency (RF) circuit and RF device for implementing various communication protocols.

The communication apparatus 400 may include a short-range communication unit 410, a location information unit 420, a V2X communication unit 430, an optical communication unit 440, a broadcast transceiver 450 and a processor 470.

In some implementations, the communication apparatus 400 may further include other components in addition to the components described, or may not include some of the components described.

The short-range communication unit 410 is a unit for facilitating short-range communications. Suitable technologies for implementing such short-range communications include Bluetooth, Radio Frequency IDentification (RFID), Infrared Data Association (IrDA), Ultra-WideBand (UWB), ZigBee, Near Field Communication (NFC), Wireless-Fidelity (Wi-Fi), Wi-Fi Direct, Wireless USB (Wireless Universal Serial Bus), and the like.

The short-range communication unit 410 may construct short-range area networks to perform short-range communication between the vehicle 100 and at least one external device.

The location information unit 420 is a unit for acquiring position information. For example, the location information unit 420 may include a Global Positioning System (GPS) module or a Differential Global Positioning System (DGPS) module.

The V2X communication unit 430 is a unit for performing wireless communications with a server (Vehicle to Infra; V2I), another vehicle (Vehicle to Vehicle; V2V), or a pedestrian (Vehicle to Pedestrian; V2P). The V2X communication unit 430 may include an RF circuit implementing a communication protocol with the infra (V2I), a communication protocol between the vehicles (V2V) and a communication protocol with a pedestrian (V2P).

The optical communication unit 440 is a unit for performing communication with an external device through the medium of light. The optical communication unit 440 may include a light-emitting diode for converting an electric signal into an optical signal and sending the optical signal to the exterior, and a photodiode for converting the received optical signal into an electric signal.

In some implementations, the light-emitting diode may be integrated with lamps provided on the vehicle 100.

The broadcast transceiver 450 is a unit for receiving a broadcast signal from an external broadcast managing entity or transmitting a broadcast signal to the broadcast managing entity via a broadcast channel. The broadcast channel may include a satellite channel, a terrestrial channel, or both. The broadcast signal may include a TV broadcast signal, a radio broadcast signal and a data broadcast signal.

The processor 470 may control an overall operation of each unit of the communication apparatus 400.

In some implementations, the communication apparatus 400 may include a plurality of processors 470 or may not include any processor 470.

When the processor 470 is not included in the communication apparatus 400, the communication apparatus 400 may operate according to the control of a processor of another device within the vehicle 100 or the controller 170.

In some examples, the communication apparatus 400 may implement a display apparatus for a vehicle together with the user interface apparatus 200. In this instance, the display apparatus for the vehicle may be referred to as a telematics apparatus or an Audio Video Navigation (AVN) apparatus.

The communication apparatus 400 may operate according to the control of the controller 170.

The driving control apparatus 500 is an apparatus for receiving a user input for driving. In a manual mode, the vehicle 100 may be operated based on a signal provided by the driving control apparatus 500.

The driving control apparatus 500 may include a steering input device 510, an acceleration input device 530 and a brake input device 570.

The steering input device 510 may receive an input regarding a driving (ongoing) direction of the vehicle 100 from the user. In some examples, the steering input device 510 may be configured in the form of a wheel allowing a steering input in a rotating manner. In some implementations, the steering input device may also be configured in a shape of a touch screen, a touch pad or a button.

The acceleration input device 530 may receive an input for accelerating the vehicle 100 from the user. The brake input device 570 may receive an input for braking the vehicle 100 from the user. In some examples, each of the acceleration input device 530 and the brake input device 570 may be configured in the form of a pedal. In some implementations, the acceleration input device or the brake input device may also be configured in a shape of a touch screen, a touch pad or a button.

The driving control apparatus 500 may operate according to the control of the controller 170.

The vehicle operating apparatus 600 is an apparatus for electrically controlling operations of various devices within the vehicle 100.

The vehicle operating apparatus 600 may include a power train operating unit 610, a chassis operating unit 620, a door/window operating unit 630, a safety apparatus operating unit 640, a lamp operating unit 650, and an air-conditioner operating unit 660.

In some implementations, the vehicle operating apparatus 600 may further include other components in addition to the components described, or may not include some of the components described.

In some examples, the vehicle operating apparatus 600 may include a processor. Each unit of the vehicle operating apparatus 600 may individually include a processor.

The power train operating unit 610 may control an operation of a power train device. The power train operating unit 610 may include a power source operating portion 611 and a gearbox operating portion 612.

The power source operating portion 611 may perform a control for a power source of the vehicle 100.

For example, upon using a fossil fuel-based engine as the power source, the power source operating portion 611 may perform an electronic control for the engine. Accordingly, an output torque and the like of the engine may be controlled. The power source operating portion 611 may adjust the engine output torque according to the control of the controller 170. For example, upon using an electric energy-based motor as the power source, the power source operating portion 611 may perform a control for the motor. The power source operating portion 611 may adjust a rotating speed, a torque and the like of the motor according to the control of the controller 170.

The gearbox operating portion 612 may perform a control for a gearbox.

The gearbox operating portion 612 may adjust a state of the gearbox. The gearbox operating portion 612 may change the state of the gearbox into drive (forward) (D), reverse (R), neutral (N) or parking (P).

In some examples, when an engine is the power source, the gearbox operating portion 612 may adjust a locked state of a gear in the drive (D) state.

The chassis operating unit 620 may control an operation of a chassis device.

The chassis operating unit 620 may include a steering operating portion 621, a brake operating portion 622 and a suspension operating portion 623.

The steering operating portion 621 may perform an electronic control for a steering apparatus within the vehicle 100. The steering operating portion 621 may change a driving direction of the vehicle.

The brake operating portion 622 may perform an electronic control for a brake apparatus within the vehicle 100. For example, the brake operating portion 622 may control an operation of brakes provided at wheels to reduce speed of the vehicle 100.

In some examples, the brake operating portion 622 may individually control each of a plurality of brakes. The brake operating portion 622 may differently control braking force applied to each of a plurality of wheels.

The suspension operating portion 623 may perform an electronic control for a suspension apparatus within the vehicle 100. For example, the suspension operating portion 623 may control the suspension apparatus to reduce vibration of the vehicle 100 when a bump is present on a road.

In some examples, the suspension operating portion 623 may individually control each of a plurality of suspensions.

The door/window operating unit 630 may perform an electronic control for a door apparatus or a window apparatus within the vehicle 100.

The door/window operating unit 630 may include a door operating portion 631 and a window operating portion 632.

The door operating portion 631 may perform the control for the door apparatus. The door operating portion 631 may control opening or closing of a plurality of doors of the vehicle 100. The door operating portion 631 may control opening or closing of a trunk or a tail gate. The door operating portion 631 may control opening or closing of a sunroof.

The window operating portion 632 may perform the electronic control for the window apparatus. The window operating portion 632 may control opening or closing of a plurality of windows of the vehicle 100.

The safety apparatus operating unit 640 may perform an electronic control for various safety apparatuses within the vehicle 100.

The safety apparatus operating unit 640 may include an airbag operating portion 641, a seatbelt operating portion 642 and a pedestrian protecting apparatus operating portion 643.

The airbag operating portion 641 may perform an electronic control for an airbag apparatus within the vehicle 100. For example, the airbag operating portion 641 may control the airbag to be deployed upon a detection of a risk.

The seatbelt operating portion 642 may perform an electronic control for a seatbelt apparatus within the vehicle 100. For example, the seatbelt operating portion 642 may control passengers to be motionlessly seated in seats 110FL, 110FR, 110RL, 110RR using seatbelts upon a detection of a risk.

The pedestrian protecting apparatus operating portion 643 may perform an electronic control for a hood lift and a pedestrian airbag. For example, the pedestrian protecting apparatus operating portion 643 may control the hood lift and the pedestrian airbag to be open up upon detecting pedestrian collision.

The lamp operating unit 650 may perform an electronic control for various lamp apparatuses within the vehicle 100.

The air-conditioner operating unit 660 may perform an electronic control for an air conditioner within the vehicle 100. For example, the air-conditioner operating unit 660 may control the air conditioner to supply cold air into the vehicle when internal temperature of the vehicle is high.

The vehicle operating apparatus 600 may include a processor. Each unit of the vehicle operating apparatus 600 may individually include a processor.

The vehicle operating apparatus 600 may operate according to the control of the controller 170.

The operation system 700 is a system that controls various driving modes of the vehicle 100. The operation system 700 may operate in an autonomous driving mode.

The operation system 700 may include a driving system 710, a parking exit system 740 and a parking system 750.

According to implementations, the operation system 700 may further include other components in addition to components to be described, or may not include some of the components to be described.

In some examples, the operation system 700 may include at least one processor. Each unit of the operation system 700 may individually include at least one processor.

According to implementations, the operation system may be implemented by the controller 170 when it is implemented in a software configuration.

In some implementations, the operation system 700 may be implemented by at least one of the user interface apparatus 200, the object detecting apparatus 300, the communication apparatus 400, the vehicle operating apparatus 600 and the controller 170.

The driving system 710 may perform driving of the vehicle 100.

The driving system 710 may receive navigation information from a navigation system 770, transmit a control signal to the vehicle operating apparatus 600, and perform driving of the vehicle 100.

The driving system 710 may receive object information from the object detecting apparatus 300, transmit a control signal to the vehicle operating apparatus 600 and perform driving of the vehicle 100.

The driving system 710 may receive a signal from an external device through the communication apparatus 400, transmit a control signal to the vehicle operating apparatus 600, and perform driving of the vehicle 100.

The parking exit system 740 may perform an exit of the vehicle 100 from a parking lot.

The parking exit system 740 may receive navigation information from the navigation system 770, transmit a control signal to the vehicle operating apparatus 600, and perform the exit of the vehicle 100 from the parking lot.

The parking exit system 740 may receive object information from the object detecting apparatus 300, transmit a control signal to the vehicle operating apparatus 600 and perform the exit of the vehicle 100 from the parking lot.

The parking exit system 740 may receive a signal from an external device through the communication apparatus 400, transmit a control signal to the vehicle operating apparatus 600, and perform the exit of the vehicle 100 from the parking lot.

The parking system 750 may perform parking of the vehicle 100.

The parking system 750 may receive navigation information from the navigation system 770, transmit a control signal to the vehicle operating apparatus 600, and park the vehicle 100.

The parking system 750 may receive object information from the object detecting apparatus 300, transmit a control signal to the vehicle operating apparatus 600 and park the vehicle 100.

The parking system 750 may receive a signal from an external device through the communication apparatus 400, transmit a control signal to the vehicle operating apparatus 600, and park the vehicle 100.

The navigation system 770 may provide navigation information. The navigation information may include at least one of map information, information regarding a set destination, path information according to the set destination, information regarding various objects on a path, lane information and current location information of the vehicle.

The navigation system 770 may include a memory and a processor. The memory may store the navigation information. The processor may control an operation of the navigation system 770.

In some implementations, the navigation system 770 may update prestored information by receiving information from an external device through the communication apparatus 400.

In some implementations, the navigation system 770 may be classified as a sub component of the user interface apparatus 200.

The sensing unit 120 may sense a status of the vehicle. The sensing unit 120 may include a posture sensor (e.g., a yaw sensor, a roll sensor, a pitch sensor, etc.), a collision sensor, a wheel sensor, a speed sensor, a tilt sensor, a weight-detecting sensor, a heading sensor, a gyro sensor, a position module, a vehicle forward/backward movement sensor, a battery sensor, a fuel sensor, a tire sensor, a steering sensor by a turn of a handle, a vehicle internal temperature sensor, a vehicle internal humidity sensor, an ultrasonic sensor, an illumination sensor, an accelerator position sensor, a brake pedal position sensor, and the like.

The sensing unit 120 may acquire sensing signals with respect to vehicle-related information, such as a posture, a collision, an orientation, a position (GPS information), an angle, a speed, an acceleration, a tilt, a forward/backward movement, a battery, a fuel, tires, lamps, internal temperature, internal humidity, a rotated angle of a steering wheel, external illumination, pressure applied to an accelerator, pressure applied to a brake pedal and the like.

The sensing unit 120 may further include an accelerator sensor, a pressure sensor, an engine speed sensor, an air flow sensor (AFS), an air temperature sensor (ATS), a water temperature sensor (WTS), a throttle position sensor (TPS), a TDC sensor, a crank angle sensor (CAS), and the like.

The interface unit 130 may serve as a path allowing the vehicle 100 to interface with various types of external devices connected thereto. For example, the interface unit 130 may be provided with a port connectable with a mobile terminal, and connected to the mobile terminal through the port. In this instance, the interface unit 130 may exchange data with the mobile terminal.

In some examples, the interface unit 130 may serve as a path for supplying electric energy to the connected mobile terminal. When the mobile terminal is electrically connected to the interface unit 130, the interface unit 130 supplies electric energy supplied from a power supply unit 190 to the mobile terminal according to the control of the controller 170.

The memory 140 is electrically connected to the controller 170. The memory 140 may store basic data for units, control data for controlling operations of units and input/output data.

The memory 140 may be a variety of storage devices, such as ROM, RAM, EPROM, a flash drive, a hard drive and the like in a hardware configuration. The memory 140 may store various data for overall operations of the vehicle 100, such as programs for processing or controlling the controller 170.

According to implementations, the memory 140 may be integrated with the controller 170 or implemented as a sub component of the controller 170.

The controller 170 may control an overall operation of each unit of the vehicle 100. The controller 170 may be referred to as an Electronic Control Unit (ECU).

The power supply unit 190 may supply power for an operation of each component according to the control of the controller 170. Specifically, the power supply unit 190 may receive power supplied from an internal battery of the vehicle, and the like.

At least one processor and the controller 170 included in the vehicle 100 may be implemented using at least one of application specific integrated circuits (ASICs), digital signal processors (DSPs), digital signal processing devices (DSPDs), programmable logic devices (PLDs), field programmable gate arrays (FPGAs), processors, controllers, micro controllers, microprocessors, and electric units performing other functions.

In some examples, the vehicle 100 may include a path providing device 800.

The path providing device 800 may control at least one of those components illustrated in FIG. 7. From this perspective, the path providing device 800 may be the controller 170.

Without a limit to this, the path providing device 800 may be a separate device, independent of the controller 170. When the path providing device 800 is implemented as a component independent of the controller 170, the path providing device 800 may be provided on a part of the vehicle 100. In some examples, the path providing device 800 may include an electric circuit, a processor, a memory, a controller, a transceiver, or the like.

Hereinafter, description will be given of implementations in which the path providing device 800 is a component which is separate from the controller 170, for the sake of explanation. As such, according to implementations described in this disclosure, the functions (operations) and control techniques described in relation to the path providing device 800 may be executed by the controller 170 of the vehicle. However, in general, the path providing device 800 may be implemented by one or more other components in various ways.

Also, the path providing device 800 described herein may include some of the components illustrated in FIG. 7 and various components included in the vehicle. For the sake of explanation, the components illustrated in FIG. 7 and the various components included in the vehicle will be described with separate names and reference numbers.

Hereinafter, description will be given in more detail of a method of autonomously traveling a vehicle in an optimized manner or providing path information optimized for the travel of the vehicle, with reference to the accompanying drawings.

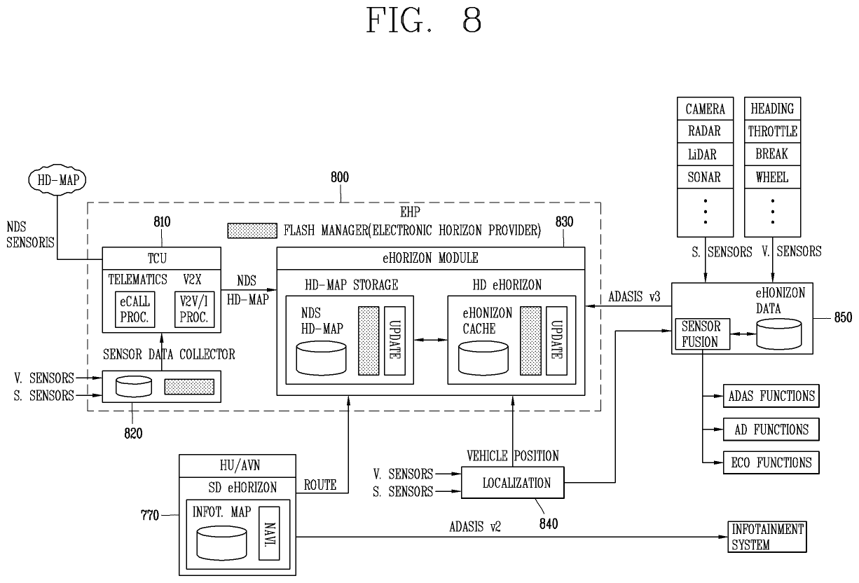

FIG. 8 is a diagram illustrating Electronic Horizon Provider (EHP) as an example of a path providing device.

Referring to FIG. 8, a path providing device 800 associated with the present disclosure may autonomously control the vehicle 100 based on eHorizon (electronic Horizon).

The path providing device 800 may be an electronic horizon provider (EHP).

Here, Electronic Horizon may be referred to as ‘ADAS Horizon’, ‘ADASIS Horizon’, ‘Extended Driver Horizon’ or ‘eHorizon’.

The eHorizon may be understood as software, a module or a system that performs the functions role of generating a vehicle's forward path information (e.g., using high-definition (HD) map data), configuring the vehicle's forward path information based on a specified standard (protocol) (e.g., a standard specification defined by the ADAS), and transmitting the configured vehicle forward path information to an application (e.g., an ADAS application, a map application, etc.) which may be installed in a module (for example, an ECU, a controller 170, a navigation system 770, etc.) of the vehicle or in the vehicle requiring map information (or path information).

In some systems, the vehicle's forward path (or a path to the destination) is only provided as a single path based on a navigation map. In some implementations, eHorizon may provide lane-based path information based on a high-definition (HD) map.

Data generated by eHorizon may be referred to as ‘electronic horizon data’ or ‘eHorizon data’.

The electronic horizon data may be described as driving plan data used when generating a driving control signal of the vehicle 100 in a driving (traveling) system. For example, the electronic horizon data may be understood as driving plan data in a range from a point where the vehicle 100 is located to horizon.

Here, the horizon may be understood as a point in front of the point where the vehicle 100 is located, by a preset distance, on the basis of a preset travel path. The horizon may refer to a point where the vehicle 100 is to reach after a predetermined time from the point, at which the vehicle 100 is currently located, along a preset travel path. Here, the travel path refers to a path for the vehicle to travel up to a final destination, and may be set by a user input.

Electronic horizon data may include horizon map data and horizon path data. The horizon map data may include at least one of topology data, ADAS data, HD map data, and dynamic data. In some implementations, the horizon map data may include a plurality of layers. For example, the horizon map data may include a first layer that matches topology data, a second layer that matches ADAS data, a third layer that matches HD map data, and a fourth layer that matches dynamic data. The horizon map data may further include static object data.

Topology data may be described as a map created by connecting road centers. Topology data is suitable for roughly indicating the position of a vehicle and may be in the form of data mainly used in a navigation for a driver. Topology data may be understood as data for road information excluding lane-related information. Topology data may be generated based on data received by an infrastructure through V2I. Topology data may be based on data generated in an infrastructure. Topology data may be based on data stored in at least one memory included in the vehicle 100.

ADAS data may refer to data related to road information. ADAS data may include at least one of road slope data, road curvature data, and road speed limit data. ADAS data may further include no-passing zone data. ADAS data may be based on data generated in an infrastructure. ADAS data may be based on data generated by the object detecting apparatus 300.

ADAS data may be named road information data.

HD map data may include detailed lane-unit topology information of a road, connection information of each lane, and feature information for localization of a vehicle (e.g., traffic signs, lane marking/attributes, road furniture, etc.). HD map data may be based on data generated in an infrastructure.

Dynamic data may include various dynamic information that may be generated on a road. For example, the dynamic data may include construction information, variable-speed lane information, road surface state information, traffic information, moving object information, and the like. Dynamic data may be based on data received by an infrastructure. Dynamic data may be based on data generated by the object detecting apparatus 300.

The path providing device 800 may provide map data within a range from a point where the vehicle 100 is located to the horizon. The horizon path data may be described as a trajectory that the vehicle 100 may take within the range from the point where the vehicle 100 is located to the horizon. The horizon path data may include data indicating a relative probability to select one road at a decision point (e.g., fork, intersection, crossroads, etc.). Relative probability may be calculated based on a time taken to arrive at a final destination. For example, if a shorter time is taken to arrive at the final destination when selecting a first road than when selecting a second road at a decision point, the probability to select the first road may be calculated higher than the probability to select the second road.

The horizon path data may include a main path and a sub path. The main path may be understood as a trajectory connecting roads with a higher relative probability to be selected. The sub path may be merged with or diverged from at least one point on the main path. The sub path may be understood as a trajectory connecting at least one road having a low relative probability to be selected at the at least one decision point on the main path.

eHorizon may be classified into categories such as software, a system, and the like. eHorizon denotes a configuration of fusing real-time events, such as road shape information of a high-definition map, real-time traffic signs, road surface conditions, accidents and the like, under a connected environment of an external server (cloud server), V2X (Vehicle to everything) or the like, and providing the fused information to the autonomous driving system and the infotainment system.

In other words, eHorizon may perform the role of transferring a road shape on a high-definition map and real-time events with respect to the front of the vehicle to the autonomous driving system and the infotainment system under an external server/V2X environment.

In order to effectively transfer eHorizon data (information) transmitted from eHorizon (i.e., external server) to the autonomous driving system and the infotainment system, a data specification and transmission method may be formed in accordance with a technical standard called “Advanced Driver Assistance Systems Interface Specification (ADASIS).”

The vehicle 100 may use information, which is received (generated) in eHorizon, in an autonomous driving system and/or an infotainment system.

For example, the autonomous driving system may use information provided by eHorizon in safety and ECO aspects.

In terms of the safety aspect, the vehicle 100 may perform an Advanced Driver Assistance System (ADAS) function such as Lane Keeping Assist (LKA), Traffic Jam Assist (TJA) or the like, and/or an AD (AutoDrive) function such as passing, road joining, lane change or the like, by using road shape information and event information received from eHorizon and surrounding object information sensed through the sensing unit 840 provided in the vehicle. Furthermore, in terms of the ECO aspect, the path providing device 800 may receive slope information, traffic light information, and the like related to a forward road from eHorizon, to control the vehicle so as to get efficient engine output, thereby enhancing fuel efficiency.

The infotainment system may include convenience aspect.

For example, the vehicle 100 may receive from eHorizon accident information, road surface condition information, and the like related to a road ahead of the vehicle and output them on a display unit (for example, Head Up Display (HUD), CID, Cluster, etc.) provided in the vehicle, so as to provide guide information for the driver to drive the vehicle safely.

eHorizon (external server) may receive position information related to various types of event information (e.g., road surface condition information, construction information, accident information, etc.) occurred on roads and/or road-based speed limit information from the vehicle 100 or other vehicles or may collect such information from infrastructures (for example, measuring devices, sensing devices, cameras, etc.) installed on the roads.

In addition, the event information and the road-based speed limit information may be linked to map information or may be updated.

In addition, the position information related to the event information may be divided into lane units.

By using such information, the eHorizon system (EHP) may provide information necessary for the autonomous driving system and the infotainment system to each vehicle, based on a high-definition map on which road conditions (or road information) may be determined on the lane basis.

In other words, an Electronic Horizon (eHorizon) Provider (EHP) may provide an absolute high-definition map using absolute coordinates of road-related information (for example, event information, position information regarding the vehicle 100, etc.) based on a high-definition map.

The road-related information provided by the eHorizon may be information included in a predetermined area (predetermined space) with respect to the vehicle 100.

The EHP may be understood as a component which is included in an eHorizon system and performs functions provided by the eHorizon (or eHorizon system).

The path providing device 800 may be EHP, as shown in FIG. 8.

The path providing device 800 (EHP) may receive a high-definition map from an external server (or a cloud server), generate path (route) information to a destination in lane units, and transmit the high-definition map and the path information generated in the lane units to a module or application (or program) of the vehicle requiring the map information and the path information.

FIG. 8 illustrates an overall structure of an Electronic Horizon (eHorizon) system.

The path providing device 800 (EHP) may include a telecommunication control unit (TCU) 810 that receives a high-definition map (HD-map) existing in a cloud server.

The TCU 810 may be the communication apparatus 400 described above, and may include at least one of components included in the communication apparatus 400.

The TCU 810 may include a telematics module or a vehicle to everything (V2X) module.

The TCU 810 may receive an HD map that complies with the Navigation Data Standard (NDS) (or conforms to the NDS standard) from the cloud server.

In addition, the HD map may be updated by reflecting data sensed by sensors provided in the vehicle and/or sensors installed around road, according to the sensor ingestion interface specification (SENSORIS).

The TCU 810 may download the HD map from the cloud server through the telematics module or the V2X module.

In addition, the path providing device 800 may include an interface unit 820. Specifically, the interface unit 820 receives sensing information from one or more sensors provided in the vehicle 100.

In some cases, the interface unit 820 may be referred to as a sensor data collector.

The interface unit 820 collects (receives) information sensed by sensors (V.Sensors) provided in the vehicle for detecting a manipulation of the vehicle (e.g., heading, throttle, break, wheel, etc.) and sensors (S.Sensors) for detecting surrounding information of the vehicle (e.g., Camera, Radar, LiDAR, Sonar, etc.)

The interface unit 820 may transmit the information sensed through the sensors provided in the vehicle to the TCU 810 (or a processor 830) so that the information is reflected in the HD map. For example, the interface unit 820 may include at least one of an electric circuit, a processor, a communication device, a signal receiver, a signal transmitter, transceiver, or the like. In some examples, the interface unit 820 may be a software module including one or more computer programs or instructions. In some cases, the interface unit 820 may be a part of the processor 830.

The communication unit 810 may update the HD map stored in the cloud server by transmitting the information transmitted from the interface unit 820 to the cloud server.

The path providing device 800 may include a processor 830 (or an eHorizon module).

The processor 830 may control the communication unit 810 and the interface unit 820.

The processor 830 may store the HD map received through the communication unit 810, and update the HD map using the information received through the interface unit 820. This operation may be performed in the storage part 832 of the processor 830.

The processor 830 may receive first path information from an audio video navigation (AVN) or a navigation system 770.

The first path information is route information provided in the related art and may be information for guiding a traveling path (travel path, driving path, or driving route) to a destination.

In this case, the first path information provided in the related art provides only one path information and does not distinguish lanes.

In some implementations, when the processor 830 receives the first path information, the processor 830 may generate second path information for guiding, in lane units, a traveling path up to the destination set in the first path information, by using the HD map and the first path information. For example, the operation may be performed by a calculation part 834 of the processor 830.

In addition, the eHorizon system may include a localization unit 840 for identifying the position or location of the vehicle by using information sensed through the sensors (V.Sensors, S.Sensors) provided in the vehicle.

The localization unit 840 may transmit the position information of the vehicle to the processor 830 to match the position of the vehicle identified by using the sensors provided in the vehicle with the HD map.

The processor 830 may match the position of the vehicle 100 with the HD map based on the position information of the vehicle.

The processor 830 may generate horizon map data. The processor 830 may generate horizon map data. The processor 830 may generate horizon path data.

The processor 830 may generate electronic horizon data by reflecting the traveling (driving) situation of the vehicle 100. For example, the processor 830 may generate electronic horizon data based on traveling direction data and traveling speed data of the vehicle 100.

The processor 830 may merge the generated electronic horizon data with previously-generated electronic horizon data. For example, the processor 830 may connect horizon map data generated at a first time point with horizon map data generated at a second time point on the position basis. For example, the processor 830 may connect horizon path data generated at a first time point with horizon path data generated at a second time point on the position basis.

The processor 830 may include a memory, an HD map processing part, a dynamic data processing part, a matching part, and a path generating part.

The HD map processing part may receive HD map data from a server through the TCU.

The HD map processing part may store the HD map data. In some implementations, the HD map processing part may also process the HD map data. The dynamic data processing part may receive dynamic data from the object detecting device. The dynamic data processing part may receive the dynamic data from a server. The dynamic data processing part may store the dynamic data. In some implementations, the dynamic data processing part may process the dynamic data.

The matching part may receive an HD map from the HD map processing part. The matching part may receive dynamic data from the dynamic data processing part. The matching part may generate horizon map data by matching the HD map data with the dynamic data.

In some implementations, the matching part may receive topology data. The matching part may receive ADAS data. The matching part may generate horizon map data by matching the topology data, the ADAS data, the HD map data, and the dynamic data. The path generating part may generate horizon path data. The path generating part may include a main path generator and a sub path generator. The main path generator may generate main path data. The sub path generator may generate sub path data.

In addition, the eHorizon system may include a fusion unit 850 for fusing information (data) sensed through the sensors provided in the vehicle and eHorizon data generated by the eHorizon module (control unit).

For example, the fusion unit 850 may update an HD map by fusing sensing data sensed by the vehicle with an HD map corresponding to eHorizon data, and provide the updated HD map to an ADAS function, an AD (AutoDrive) function, or an ECO function.

In some implementations, the fusion unit 850 may provide the updated HD map even to the infotainment system.

FIG. 8 illustrates that the path providing device 800 merely includes the communication unit 810, the interface unit 820, and the processor 830, but the present disclosure is not limited thereto.

The path providing device 800 may further include at least one of the localization unit 840 and the fusion unit 850.

In addition, the path providing device 800 (EHP) may further include a navigation system 770.

With such a configuration, when at least one of the localization unit 840, the fusion unit 850, and the navigation system 770 is included in the path providing device 800 (EHP), the functions/operations/controls performed by the included configuration may be understood as being performed by the processor 830. In some examples, the localization unit 840 may be referred to as a sensing unit.

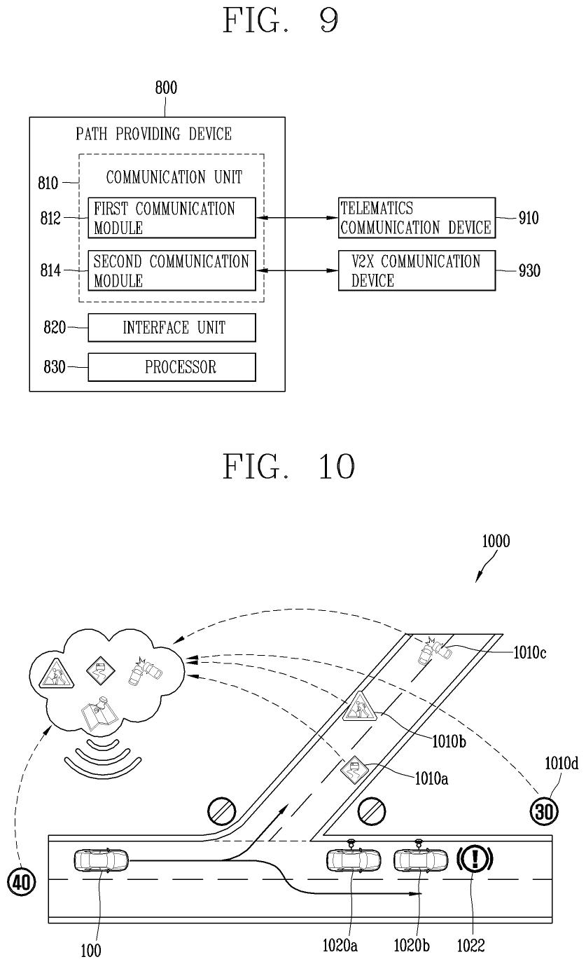

FIG. 9 is a block diagram illustrating an example of a path providing device (e.g., the EHP of FIG. 8) in more detail.

The path providing device refers to a device for providing a route (or path) to a vehicle. For example, the path providing device may be a device mounted on a vehicle to perform communication through CAN communication and generate messages for controlling the vehicle and/or electric components mounted on the vehicle.

As another example, the path providing device may be located outside the vehicle, like a server or a communication device, and may perform communication with the vehicle through a mobile communication network. In this case, the path providing device may remotely control the vehicle and/or the electric components mounted on the vehicle using the mobile communication network.

The path providing device 800 is provided in the vehicle, and may be implemented as an independent device detachable from the vehicle or may be integrally installed on the vehicle to construct a part of the vehicle 100.

Referring to FIG. 9, the path providing device 800 includes a communication unit 810, an interface unit 820, and a processor 830.

The communication unit 810 is configured to perform communications with various components provided in the vehicle.

For example, the communication unit 810 may receive various information provided through a controller area network (CAN).

The communication unit 810 may include a first communication module 812, and the first communication module 812 may receive an HD map provided through telematics. In other words, the first communication module 812 is configured to perform ‘telematics communication’.

The first communication module 812 performing the telematics communication may perform communication with a server and the like by using a satellite navigation system or a base station provided by mobile communication such as 4G or 5G. For instance, the first communication module 812 may include an electric circuit, a processor, a controller, a transceiver, or the like. The first communication module 812 may perform communication with a telematics communication device 910. The telematics communication device may include a server provided by a portal provider, a vehicle provider and/or a mobile communication company.

The processor 830 of the path providing device 800 may determine absolute coordinates of road-related information (event information) based on ADAS MAP received from an external server (eHorizon) through the first communication module 812. In addition, the processor 830 may autonomously drive the vehicle or perform a vehicle control using the absolute coordinates of the road-related information (event information). For instance, the processor 830 may include an electric circuit, an integrated circuit, or the like.

The communication unit 810 may include a second communication module 814, and the second communication module 814 may receive various types of information provided through vehicle to everything (V2X) communication. In other words, the second communication module 814 is configured to perform ‘V2X communication’. The V2X communication may be defined as a technology of exchanging or sharing information, such as traffic condition and the like, while communicating with road infrastructures and other vehicles during driving. For instance, the second communication module 814 may include an electric circuit, a processor, a controller, a transceiver, or the like.

The second communication module 814 may perform communication with a V2X communication device 930. The V2X communication device may include a mobile terminal belonging to a pedestrian or a person riding a bike, a fixed terminal installed on a road, another vehicle, and the like.

Here, the another vehicle may denote at least one of vehicles existing within a predetermined distance from the vehicle 100 or vehicles approaching by a predetermined distance or shorter with respect to the vehicle 100.

The present disclosure may not be limited thereto, and the another vehicle may include all the vehicles capable of performing communication with the communication unit 810. According to this specification, for the sake of explanation, an example will be described in which the another vehicle is at least one vehicle existing within a predetermined distance from the vehicle 100 or at least one vehicle approaching by a predetermined distance or shorter with respect to the vehicle 100.

The predetermined distance may be determined based on a distance capable of performing communication through the communication unit 810, determined according to a specification of a product, or determined/varied based on a user's setting or V2X communication standard.

The second communication module 814 may be configured to receive LDM data from another vehicle. The LDM data may be a V2X message (BSM, CAM, DENM, etc.) transmitted and received between vehicles through V2X communication.

The LDM data may include position information related to the another vehicle.

The processor 830 may determine a position of the vehicle relative to the another vehicle, based on the position information related to the vehicle 100 and the position information related to the another vehicle included in the LDM data received through the second communication module 814.

In addition, the LDM data may include speed information regarding another vehicle. The processor 830 may also determine a relative speed of the another vehicle using speed information of the vehicle and the speed information of the another vehicle. The speed information of the vehicle may be calculated using a degree to which the location information of the vehicle received through the communication unit 810 changes over time or calculated based on information received from the driving control apparatus 500 or the power train operating unit 610 of the vehicle 100.

The second communication module 814 may be the V2X communication unit 430 described above.

If the communication unit 810 is a component that performs communication with a device located outside the vehicle 100 using wireless communication, the interface unit 820 is a component performing communication with a device located inside the vehicle 100 using wired or wireless communication.

The interface unit 820 may receive information related to driving of the vehicle from most of electric components provided in the vehicle 100. Information transmitted from the electric component provided in the vehicle to the path providing device 800 is referred to as ‘vehicle driving information (or vehicle travel information)’.

For example, when the electric component is a sensor, the vehicle driving information may be sensing information sensed by the sensor.

Vehicle driving information includes vehicle information and surrounding information related to the vehicle. Information related to the inside of the vehicle with respect to a frame of the vehicle may be defined as the vehicle information, and information related to the outside of the vehicle may be defined as the surrounding information.

The vehicle information refers to information related to the vehicle itself. For example, the vehicle information may include a traveling speed, a traveling direction, an acceleration, an angular velocity, a location (GPS), a weight, a number of passengers on board the vehicle, a braking force of the vehicle, a maximum braking force, air pressure of each wheel, a centrifugal force applied to the vehicle, a travel mode of the vehicle (autonomous travel mode or manual travel mode), a parking mode of the vehicle (autonomous parking mode, automatic parking mode, manual parking mode), whether or not a user is on board the vehicle, and information associated with the user.

The surrounding information refers to information related to another object located within a predetermined range around the vehicle, and information related to the outside of the vehicle. The surrounding information of the vehicle may be a state of a road surface on which the vehicle is traveling (e.g., a frictional force), the weather, a distance from a preceding (succeeding) vehicle, a relative speed of a preceding (succeeding) vehicle, a curvature of a curve when a driving lane is the curve, information associated with an object existing in a reference region (predetermined region) based on the vehicle, whether or not an object enters (or leaves) the predetermined region, whether or not the user exists near the vehicle, information associated with the user (for example, whether or not the user is an authenticated user), and the like.

The surrounding information may also include ambient brightness, temperature, a position of the sun, information related to a nearby subject (a person, another vehicle, a sign, etc.), a type of a driving road surface, a landmark, line information, and driving lane information, and information for an autonomous travel/autonomous parking/automatic parking/manual parking mode.

In addition, the surrounding information may further include a distance from an object existing around the vehicle to the vehicle, collision possibility, a type of an object, a parking space for the vehicle, an object for identifying the parking space (for example, a parking line, a string, another vehicle, a wall, etc.), and the like.

The vehicle driving information is not limited to the example described above and may include all information generated from the components provided in the vehicle.

In some examples, the processor 830 is configured to control one or more electric components provided in the vehicle using the interface unit 820.

Specifically, the processor 830 may determine whether or not at least one of a plurality of preset conditions is satisfied, based on vehicle driving information received through the communication unit 810. According to a satisfied condition, the processor 830 may control the one or more electric components in different ways.

In connection with the preset conditions, the processor 830 may detect an occurrence of an event in an electric component provided in the vehicle and/or application, and determine whether the detected event meets a preset condition. At this time, the processor 830 may also detect the occurrence of the event from information received through the communication unit 810.

The application may be implemented, for example, as a widget, a home launcher, and the like, and refers to various types of programs that may be executed on the vehicle. Accordingly, the application may be a program that performs various functions, such as a web browser, a video playback, message transmission/reception, schedule management, or application update.

In addition, the application may include at least one of forward collision warning (FCW), blind spot detection (BSD), lane departure warning (LDW), pedestrian detection (PD), Curve Speed Warning (CSW), and turn-by-turn navigation (TBT).

For example, the occurrence of the event may be a missed call, presence of an application to be updated, a message arrival, start on, start off, autonomous travel on/off, pressing of an LCD awake key, an alarm, an incoming call, a missed notification, and the like.

As another example, the occurrence of the event may be a generation of an alert set in the advanced driver assistance system (ADAS), or an execution of a function set in the ADAS. For example, the occurrence of the event may be an occurrence of forward collision warning, an occurrence of blind spot detection, an occurrence of lane departure warning, an occurrence of lane keeping assist warning, or an execution of autonomous emergency braking.

As another example, the occurrence of the event may also be a change from a forward gear to a reverse gear, an occurrence of an acceleration greater than a predetermined value, an occurrence of a deceleration greater than a predetermined value, a change of a power device from an internal combustion engine to a motor, or a change from the motor to the internal combustion engine.

In addition, even when various electronic control units (ECUs) provided in the vehicle perform specific functions, it may be determined as the occurrence of the events.

For example, when a generated event satisfies the preset condition, the processor 830 may control the interface unit 820 to display information corresponding to the satisfied condition on one or more displays provided in the vehicle.

FIG. 10 is a diagram illustrating an example of eHorizon.

Referring to FIG. 10, the path providing device 800 may autonomously drive the vehicle 100 on the basis of eHorizon.

eHorizon may be classified into categories such as software, a system, and the like. The eHorizon denotes a configuration in which road shape information on a detailed map under a connected environment of an external server (cloud), V2X (Vehicle to everything) or the like and real-time events such as real-time traffic signs, road surface conditions, accidents and the like are merged to provide relevant information to autonomous driving systems and infotainment systems.

For example, eHorizon may refer to an external server (a cloud or a cloud server).

In other words, eHorizon may perform the role of transferring a road shape on a high-definition map and real-time events with respect to the front of the vehicle to the autonomous driving system and the infotainment system under an external server/V2X environment.

In order to effectively transfer eHorizon data (information) transmitted from eHorizon (i.e., external server) to the autonomous driving system and the infotainment system, a data specification and transmission method may be formed in accordance with a technical standard called “Advanced Driver Assistance Systems Interface Specification (ADASIS).”

The path providing device 800 may use information, which is received from eHorizon, in the autonomous driving system and/or the infotainment system.

For example, the autonomous driving system may be divided into a safety aspect and an ECO aspect.

In terms of the safety aspect, the vehicle 100 may perform an Advanced Driver Assistance System (ADAS) function such as Lane Keeping Assist (LKA), Traffic Jam Assist (TJA) or the like, and/or an AD (AutoDrive) function such as passing, road joining, lane change or the like, by using road shape information and event information received from eHorizon and surrounding object information sensed through the sensing unit 840 provided in the vehicle.

Furthermore, in terms of the ECO aspect, the path providing device 800 may receive slope information, traffic light information, and the like related to a forward road from eHorizon, to control the vehicle so as to get efficient engine output, thereby enhancing fuel efficiency.

The infotainment system may include convenience aspect.

For example, the vehicle 100 may receive from eHorizon accident information, road surface condition information, and the like related to a road ahead of the vehicle and output them on a display unit (for example, Head Up Display (HUD), CID, Cluster, etc.) provided in the vehicle, so as to provide guide information for the driver to drive the vehicle safely.

Referring to FIG. 10, the eHorizon (external server) may receive location information related to various types of event information (e.g., road surface condition information 1010a, construction information 1010b, accident information 1010c, etc.) occurred on roads and/or road-based speed limit information 1010d from the vehicle 100 or other vehicles 1020a and 1020b or may collect such information from infrastructures (for example, measuring devices, sensing devices, cameras, etc.) installed on the roads.

In addition, the event information and the road-based speed limit information may be linked to map information or may be updated.

In addition, the position information related to the event information may be divided into lane units.

By using such information, the eHorizon (external server) may provide information necessary for the autonomous driving system and the infotainment system to each vehicle, based on a high-definition map capable of determining a road situation (or road information) in units of lanes of the road.

In other words, the eHorizon (external server) may provide an absolute highly-detailed map using an absolute coordinate of road-related information (for example, event information, location information of the vehicle 100, etc.) based on a detailed map.

The road-related information provided by the eHorizon may be information corresponding to a predetermined region (predetermined space) with respect to the vehicle 100.

In some implementations, the path providing device may acquire position information related to another vehicle through communication with the another vehicle. Communication with the another vehicle may be performed through V2X (Vehicle to everything) communication, and data transmitted/received to/from the another vehicle through the V2X communication may be data in a format defined by a Local Dynamic Map (LDM) standard.

The LDM denotes a conceptual data storage located in a vehicle control unit (or ITS station) including information related to a safe and normal operation of an application (or application program) provided in a vehicle (or an intelligent transport system (ITS)). The LDM may, for example, comply with EN standards.

The LDM differs from the foregoing ADAS MAP in the data format and transmission method. For example, the ADAS MAP may correspond to a high-definition map having absolute coordinates received from eHorizon (external server), and the LDM may denote an high-definition map having relative coordinates based on data transmitted and received through V2X communication.

The LDM data (or LDM information) denotes data mutually transmitted and received through V2X communication (vehicle to everything) (for example, V2V (Vehicle to Vehicle) communication, V2I (Vehicle to Infra) communication, or V2P (Vehicle to Pedestrian) communication).

The LDM may be implemented, for example, by a storage for storing data transmitted and received through V2X communication, and the LDM may be formed (stored) in a vehicle control device provided in each vehicle.

The LDM data may denote data exchanged between a vehicle and a vehicle (infrastructure, pedestrian) or the like, for an example. The LDM data may include a Basic Safety Message (BSM), a Cooperative Awareness Message (CAM), and a Decentralized Environmental Notification message (DENM), and the like, for example.

The LDM data may be referred to as a V2X message or an LDM message, for example.

The vehicle control device may efficiently manage LDM data (or V2X messages) transmitted and received between vehicles using the LDM.

Based on LDM data received via V2X communication, the LDM may store, distribute to another vehicle, and continuously update all relevant information (for example, a location, a speed, a traffic light status, weather information, a road surface condition, and the like of the vehicle (another vehicle)) related to a traffic situation around a place where the vehicle is currently located (or a road situation for an area within a predetermined distance from a place where the vehicle is currently located).

For example, a V2X application provided in the path providing device 800 registers in the LDM, and receives a specific message such as all the DENMs in addition to a warning about a failed vehicle. Then, the LDM may automatically assign the received information to the V2X application, and the V2X application may control the vehicle based on the information assigned from the LDM.

As described above, the vehicle may control the vehicle using the LDM formed by the LDM data collected through V2X communication.

The LDM associated with the present disclosure may provide road-related information to the vehicle control device. The road-related information provided by the LDM provides only a relative distance and a relative speed with respect to another vehicle (or an event generation point), other than map information having absolute coordinates.

In other words, the vehicle may perform autonomous driving using an ADAS MAP (absolute coordinates HD map) according to the ADASIS standard provided by eHorizon, but the map may be used only to determine a road condition in a surrounding area of the vehicle.

In addition, the vehicle may perform autonomous driving using an LDM (relative coordinates HD map) formed by LDM data received through V2X communication, but there is a limitation in that accuracy is inferior due to insufficient absolute position information.

The path providing device included in the vehicle may generate a fused definition map using the ADAS MAP received from the eHorizon and the LDM data received through the V2X communication, and control (autonomously drive) the vehicle in an optimized manner using the fused definition map.

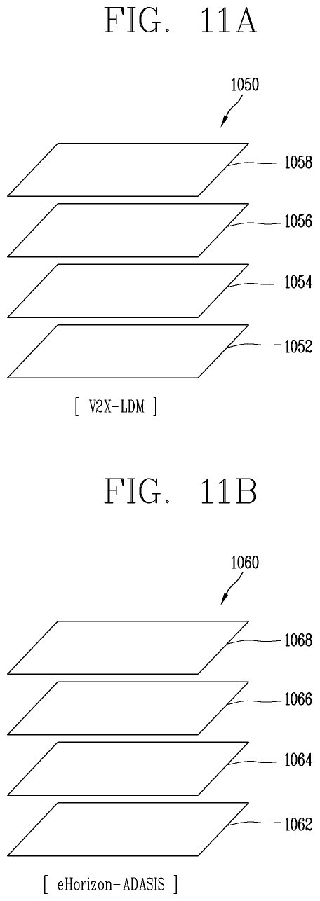

FIG. 11A illustrates an example of a data format of LDM data (or LDM) transmitted and received between vehicles via V2X communication, and FIG. 11B illustrates an example of a data format of an ADAS MAP received from an external server (eHorizon).

Referring to FIG. 11A, the LDM data (or LDM) 1050 may be formed to have four layers.

The LDM data 1050 may include a first layer 1052, a second layer 1054, a third layer 1056 and a fourth layer 1058.

The first layer 1052 may include static information, for example, map information, among road-related information.

The second layer 1054 may include landmark information (for example, specific place information specified by a maker among a plurality of place information included in the map information) among information associated with road. The landmark information may include location information, name information, size information, and the like.

The third layer 1056 may include traffic situation related information (for example, traffic light information, construction information, accident information, etc.) among information associated with roads. The construction information and the accident information may include position information.

The fourth layer 1058 may include dynamic information (for example, object information, pedestrian information, other vehicle information, etc.) among the road-related information. The object information, pedestrian information, and other vehicle information may include location information.

In other words, the LDM data 1050 may include information sensed through a sensing unit of another vehicle or information sensed through a sensing unit of the vehicle, and may include road-related information that is transformed in real time as it goes from the first layer to the fourth layer.

Referring to FIG. 11B, the ADAS MAP may be formed to have four layers similar to the LDM data.

The ADAS MAP 1060 may denote data received from eHorizon and formed to conform to the ADASIS specification.

The ADAS MAP 1060 may include a first layer 1062 to a fourth layer 1068.

The first layer 1062 may include topology information. The topology information, for example, is information that explicitly defines a spatial relationship, and may indicate map information.

The second layer 1064 may include landmark information (for example, specific place information specified by a maker among a plurality of place information included in the map information) among information associated with the road. The landmark information may include location information, name information, size information, and the like.

The third layer 1066 may include highly detailed map information. The highly detailed MAP information may be referred to as an HD-MAP, and road-related information (for example, traffic light information, construction information, accident information) may be recorded in the lane unit. The construction information and the accident information may include location information.

The fourth layer 1068 may include dynamic information (for example, object information, pedestrian information, other vehicle information, etc.). The object information, pedestrian information, and other vehicle information may include location information.

In other words, the ADAS MAP 1060 may include road-related information that is transformed in real time as it goes from the first layer to the fourth layer, similarly to the LDM data 1050.

The processor 830 may autonomously drive the vehicle 100.

For example, the processor 830 may autonomously drive the vehicle 100 based on vehicle driving information sensed through various electric components provided in the vehicle 100 and information received through the communication unit 810.

Specifically, the processor 830 may control the communication unit 810 to acquire the position information of the vehicle. For example, the processor 830 may acquire the position information (location coordinates) of the vehicle 100 through the location information unit 420 of the communication unit 810.

Furthermore, the processor 830 may control the first communication module 812 of the communication unit 810 to receive map information from an external server. Here, the first communication module 812 may receive ADAS MAP from the external server (eHorizon). The map information may be included in the ADAS MAP.

In addition, the processor 830 may control the second communication module 814 of the communication unit 810 to receive position information of another vehicle from the another vehicle. Here, the second communication module 814 may receive LDM data from the another vehicle. The position information of the another vehicle may be included in the LDM data.

The another vehicle denotes a vehicle existing within a predetermined distance from the vehicle, and the predetermined distance may be a communication-available distance of the communication unit 810 or a distance set by a user.

The processor 830 may control the communication unit to receive the map information from the external server and the position information of the another vehicle from the another vehicle.

Furthermore, the processor 830 may fuse the acquired position information of the vehicle and the received position information of the another vehicle into the received map information, and control the vehicle 100 based on at least one of the fused map information and vehicle-related information sensed through the sensing unit 840.

Here, the map information received from the external server may denote highly detailed map information (HD-MAP) included in the ADAS MAP. The highly detailed map information may be recorded with road-related information in the lane unit.

The processor 830 may fuse the position information of the vehicle 100 and the position information of the another vehicle into the map information in the lane unit. In addition, the processor 830 may fuse the road-related information received from the external server and the road-related information received from the another vehicle into the map information in the lane unit.

The processor 830 may generate ADAS MAP for the control of the vehicle using the ADAS MAP received from the external server and the vehicle-related information received through the sensing unit 840.

Specifically, the processor 830 may apply the vehicle-related information sensed within a predetermined range through the sensing unit 840 to the map information received from the external server.

Here, the predetermined range may be an available distance which may be sensed by an electric component provided in the vehicle 100 or may be a distance set by a user.

The processor 830 may control the vehicle by applying the vehicle-related information sensed within the predetermined range through the sensing unit to the map information and then additionally fusing the location (or position) information of the another vehicle thereto. In other words, when the vehicle-related information sensed within the predetermined range through the sensing unit is applied to the map information, the processor 830 may use only the information within the predetermined range from the vehicle, and thus a range capable of controlling the vehicle may be local.

However, the position information of the another vehicle received through the V2X module may be received from the another vehicle existing in a space out of the predetermined range. It may be because the communication-available distance of the V2X module communicating with the another vehicle through the V2X module is farther than a predetermined range of the sensing unit 840.

As a result, the processor 830 may fuse the location information of the another vehicle included in the LDM data received through the second communication module 814 into the map information on which the vehicle-related information has been sensed, so as to acquire the location information of the another vehicle existing in a broader range and more effectively control the vehicle using the acquired information.

For example, it is assumed that a plurality of other vehicles is crowded ahead in a lane in which the vehicle exists, and it is also assumed that the sensing unit may sense only location information related to an immediately preceding vehicle.

In this case, when only vehicle-related information sensed within a predetermined range on map information is used, the processor 830 may generate a control command for controlling the vehicle such that the vehicle overtakes the preceding vehicle.

However, a plurality of other vehicles may actually exist ahead, which may make the vehicle difficult to overtake other vehicles.

At this time, the present disclosure may acquire the location information of another vehicle received through the V2X module. At this time, the received location information of the another vehicle may include location information of not only a vehicle immediately in front of the vehicle 100 but also a plurality of other vehicles in front of the preceding vehicle.

The processor 830 may additionally fuse the location information related to the plurality of other vehicles acquired through the V2X module into map information to which the vehicle-related information is applied, so as to determine a situation where it is inappropriate to overtake the preceding vehicle.

With such configuration, the present disclosure may overcome the related art technical limitation that only vehicle-related information acquired through the sensing unit 840 is merely fused to high-definition map information and thus autonomous driving is enabled only within a predetermined range. In other words, the present disclosure may achieve more accurate and stable vehicle control by additionally fusing information related to other vehicles (e.g., speeds, locations of other vehicles), which have been received from the other vehicles located at a farther distance than the predetermined range through the V2X module, as well as vehicle-related information sensed through the sensing unit, into map information.

Vehicle control described herein may include at least one of autonomously driving the vehicle 100 and outputting a warning message associated with the driving of the vehicle.

Hereinafter, description will be given in more detail of a method in which a processor controls a vehicle using LDM data received through a V2X module, ADAS MAP received from an external server (eHorizon), and vehicle-related information sensed through a sensing unit provided in the vehicle, with reference to the accompanying drawings.

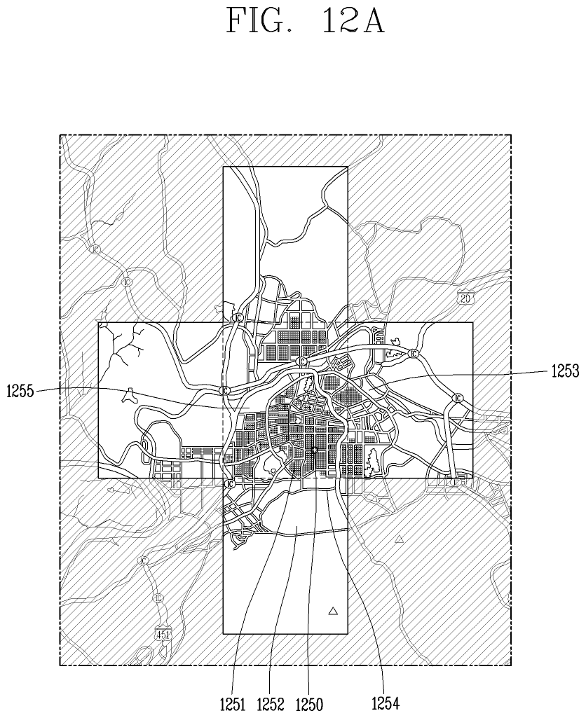

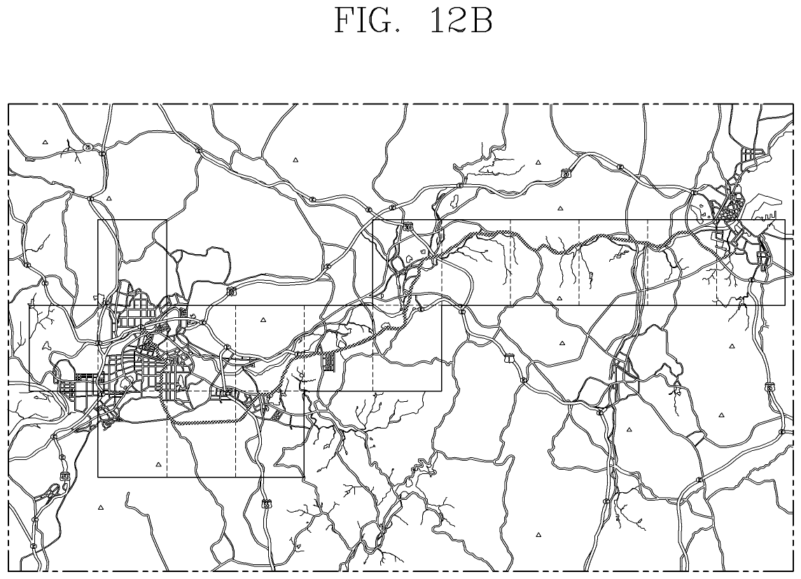

FIGS. 12A and 12B are views illustrating examples in which a communication device receives high-definition map data.

The server may divide HD map data into tile units and provide them to the path providing device 800. The processor 830 may receive HD map data in the tile units from the server or another vehicle through the communication unit 810. Hereinafter, HD map data received in tile units is referred to as ‘HD map tile’.

The HD map data is divided into tiles having a predetermined shape, and each tile corresponds to a different portion of the map. When connecting all the tiles, the full HD map data is acquired. Since the HD map data has a high capacity, the vehicle 100 should be provided with a high-capacity memory in order to download and use the full HD map data. As communication technologies are developed, it is more efficient to download, use, and delete HD map data in tile units, rather than to provide the high-capacity memory in the vehicle 100.

In the present disclosure, for the convenience of description, a case in which the predetermined shape is rectangular is described as an example, but the predetermined shape may be modified to various polygonal shapes.

The processor 830 may store the downloaded HD map tile in the memory 140. The processor 830 may delete the stored HD map tile. For example, the processor 830 may delete the HD map tile when the vehicle 100 leaves an area corresponding to the HD map tile. For example, the processor 830 may delete the HD map tile when a preset time elapses after storage.

As illustrated in FIG. 12A, when there is no preset destination, the processor 830 may receive a first HD map tile 1251 including a location (position) 1250 of the vehicle 100. The server receives data of the location 1250 of the vehicle 100 from the vehicle 100, and transmits the first HD map tile 1251 including the location 1250 of the vehicle 100 to the vehicle 100. In addition, the processor 830 may receive HD map tiles 1252, 1253, 1254, and 1255 around the first HD map tile 1251. For example, the processor 830 may receive the HD map tiles 1252, 1253, 1254, and 1255 that are adjacent to top, bottom, left, and right sides of the first HD map tile 1251, respectively. In this case, the processor 830 may receive a total of five HD map tiles. For example, the processor 830 may further receive HD map tiles located in a diagonal direction, together with the HD map tiles 1252, 1253, 1254, and 1255 adjacent to the top, bottom, left, and right sides of the first HD map tile 1251. In this case, the processor 830 may receive a total of nine HD map tiles.

As illustrated in FIG. 12B, when there is a preset destination, the processor 830 may receive tiles associated with a path from the location 1250 of the vehicle 100 to the destination. The processor 830 may receive a plurality of tiles to cover the path.

The processor 830 may receive all the tiles covering the path at one time.

Alternatively, the processor 830 may receive the entire tiles in a dividing manner while the vehicle 100 travels along the path. The processor 830 may receive only at least some of the entire tiles based on the location of the vehicle 100 while the vehicle 100 travels along the path. Thereafter, the processor 830 may continuously receive tiles during the travel of the vehicle 100 and delete the previously received tiles.

The processor 830 may generate electronic horizon data based on the HD map data.

The vehicle 100 may travel in a state where a final destination is set. The final destination may be set based on a user input received via the user interface apparatus 200 or the communication apparatus 400. In some implementations, the final destination may be set by the driving system 710.

In the state where the final destination is set, the vehicle 100 may be located within a preset distance from a first point during driving. When the vehicle 100 is located within the preset distance from the first point, the processor 830 may generate electronic horizon data having the first point as a start point and a second point as an end point. The first point and the second point may be points on the path heading to the final destination. The first point may be described as a point where the vehicle 100 is located or will be located in the near future. The second point may be described as the horizon described above.

The processor 830 may receive an HD map of an area including a section from the first point to the second point. For example, the processor 830 may request an HD map for an area within a predetermined radial distance from the section between the first point and the second point and receive the requested HD map.

The processor 830 may generate electronic horizon data for the area including the section from the first point to the second point, based on the HD map. The processor 830 may generate horizon map data for the area including the section from the first point to the second point. The processor 830 may generate horizon path data for the area including the section from the first point to the second point. The processor 830 may generate a main path for the area including the section from the first point to the second point. The processor 830 may generate data of a sub path for the area including the section from the first point to the second point.

When the vehicle 100 is located within a preset distance from the second point, the processor 830 may generate electronic horizon data having the second point as a start point and a third point as an end point. The second point and the third point may be points on the path heading to the final destination. The second point may be described as a point where the vehicle 100 is located or will be located in the near future. The third point may be described as the horizon described above. In some examples, the electronic horizon data having the second point as the start point and the third point as the end point may be geographically connected to the electronic horizon data having the first point as the start point and the second point as the end point.

The operation of generating the electronic horizon data using the second point as the start point and the third point as the end point may be performed by correspondingly applying the operation of generating the electronic horizon data having the first point as the start point and the second point as the end point.

In some implementations, the vehicle 100 may travel even when the final destination is not set.

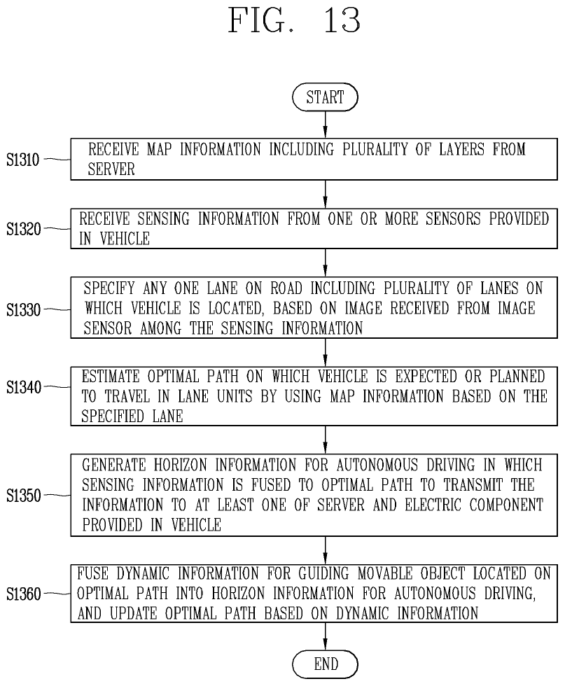

FIG. 13 is a flowchart illustrating an example of a path providing method of the path providing device of FIG. 9.

The processor 830 receives a high-definition (HD) map from an external server. In detail, the processor 830 may receive map information (HD map) having a plurality of layers from a server (external server or cloud server) (S1310).

The external server is a device capable of performing communication through the first communication module 812 and is an example of the telematics communication device 910. The high-definition map is provided with a plurality of layers. The HD map is ADAS MAP and may include at least one of the four layers described above with reference to FIG. 11B.

The map information may include the horizon map data described above. The horizon map data may mean ADAS MAP that satisfies the ADASIS standard described in FIG. 11B and is provided with a plurality of layers.

In addition, the processor 830 of the path providing device may receive sensing information from one or more sensors provided in the vehicle (S1320). The sensing information may mean information sensed (or information processed after being sensed) by each sensor. The sensing information may include various information according to types of data that may be sensed by the sensors.

The processor 830 may specify (determine) one lane in which the vehicle 100 is located on a road having a plurality of lanes based on an image that has been received from an image sensor among the sensing information (S1330). Here, the lane refers to a lane in which the vehicle 100 having the path providing device 800 is currently traveling.

The processor 830 may determine a lane in which the vehicle 100 having the path providing device 800 is currently moving by using (analyzing) an image received from an image sensor (or camera) among the sensors.

In addition, the processor 830 may estimate an optimal path (or route), in which the vehicle 100 is expected or planned to be driven based on the specified lane, in lane units using map information (S1340). Here, the optimal path may refer to the horizon pass data or main path, as described above. The present disclosure is not limited to this, and the optimal path may further include a sub path. Here, the optimal path may be referred to as a Most Preferred Path or Most Probable Path, and may be abbreviated as MPP.

That is, the processor 830 may predict or plan an optimal path, in which the vehicle 100 may travel to a destination, based on a specific lane, in which the vehicle 100 is currently driving, in lane units using map information.

The processor 830 may generate autonomous driving visibility information in which sensing information is fused with the optimal path, and transmit the generated information to a server and at least one of electric components (or electric parts) provided in the vehicle (S1350).

Here, the autonomous driving visibility information may mean the eHorizon information (or eHorizon data) described above. The autonomous driving visibility information (eHorizon information) is information (data, or environment) which the vehicle 100 uses for performing autonomous driving in lane units, namely, as illustrated in FIG. 10, may refer to autonomous driving environment data in which every information (map information, vehicles, objects, moving objects, environment, weather, etc.) within a predetermined range based on a road including an optimal path in which the vehicle 100 is to move or based on the optimal path is fused together. The autonomous driving environment data may refer to data (or overall data environment) based on which the processor 830 of the vehicle 100 autonomously drives the vehicle 100 or calculates an optimal path of the vehicle 100.

In some implementations, the autonomous driving visibility information may also mean information for guiding a driving path in lane units. This is information in which at least one of sensing information and dynamic information is fused with the optimal path, and may be information for guiding a path along which the vehicle is to finally move in lane units.

When autonomous driving visibility information refers to information for guiding a driving path in lane units, the processor 830 may generate different autonomous driving visibility information depending on whether or not a destination has been set in the vehicle 100. For example, when a destination has been set in the vehicle 100, the processor 830 may generate autonomous driving visibility information for guiding a driving path (travel path) to the destination in the lane units.

As another example, when a destination has not been set in the vehicle 100, the processor 830 may calculate a main path (Most Preferred Path (MPP)) along which the vehicle 100 is most likely to travel, and generate autonomous driving visibility information for guiding the main path (MPP) in the lane units. In this case, the autonomous driving visibility information may further include sub path information related to a sub path, which is branched from the main path (MPP) and along which the vehicle 100 is likely to travel with a higher probability than a predetermined reference.

The autonomous driving visibility information may provide a driving path up to a destination for each lane drawn on a road, thereby providing more precise and detailed path information. The autonomous driving visibility information may be path information that complies with the standard of ADASIS v3.

The processor 830 may fuse dynamic information guiding a movable object located on the optimal path with the autonomous driving visibility information, and update the optimal path based on the dynamic information (S1360). The dynamic information may be included in the map information received from the server and may be information included in any one (e.g., fourth layer 1068) of a plurality of layers.

The foregoing description is summarized as follows.

The processor 830 may generate autonomous driving visibility information for guiding a road located ahead of the vehicle in lane units using the HD map.

The processor 830 receives sensing information from one or more sensors provided in the vehicle 100 through the interface unit 820. The sensing information may be vehicle driving information.

The processor 830 may specify one lane in which the vehicle 100 is located on a road having a plurality of lanes based on an image, which has been received from an image sensor, among the sensing information. For example, when the vehicle 100 is moving in a first lane on an eight-lane road, the processor 830 may specify (determine) the first lane as a lane in which the vehicle 100 is located, based on the image received from the image sensor.

The processor 830 may estimate an optimal path, in which the vehicle 100 is expected or planned to move based on the specified lane, in lane units using the map information.

Here, the optimal path may be referred to as a Most Preferred Path or Most Probable Path, and may be abbreviated as MPP.

The vehicle 100 may autonomously travel along the optimal path. When the vehicle is traveling manually, the vehicle 100 may provide navigation information to guide the optimal path to a driver.

The processor 830 may generate autonomous driving visibility information, in which the sensing information has been fused with the optimal path. The autonomous driving visibility information may be referred to as ‘eHorizon’ or ‘electronic horizon’ or ‘electronic horizon data’.

The processor 830 may use the autonomous driving visibility information differently depending on whether a destination has been set in the vehicle 100.

For example, when a destination has been set in the vehicle 100, the processor 830 may generate an optimal path for guiding a driving path up to the destination in lane units, by using the autonomous driving visibility information.

As another example, when a destination has not been set in the vehicle 100, the processor 830 may calculate a main path, along which the vehicle 100 is most likely to travel, in lane units using the autonomous driving visibility information. In this case, the autonomous driving visibility information may further include sub path information related to a sub path, which is branched from the main path (MPP) and along which the vehicle 100 is likely to travel with a higher probability than a predetermined reference.

The autonomous driving visibility information may provide a driving path up to a destination for each lane drawn on a road, thereby providing more precise and detailed path information. The path information may be path information that complies with the standard of ADASIS v3.

The autonomous driving visibility information may be provided by subdividing a path, along which the vehicle should travel or may travel, in the lane units. The autonomous driving visibility information may include information for guiding a driving path to a destination in lane units. When the autonomous driving visibility information is displayed on a display mounted in the vehicle 100, a guide line for guiding a lane, in which the vehicle 100 may travel, on a map, and information within a predetermined range based on the vehicle 100 (e.g., roads, Landmarks, other vehicles, surrounding objects, weather information, etc.) may be displayed. In addition, a graphic object indicating the position or location of the vehicle 100 may be output on at least one lane in which the vehicle 100 is located among a plurality of lanes included in a map.

The autonomous driving visibility information may be fused with dynamic information for guiding a movable object located on the optimal path. The dynamic information may be received by the processor 830 through the communication unit 810 and/or the interface unit 820, and the processor 830 may update the optimal path based on the dynamic information. As the optimal path is updated, the autonomous driving visibility information is also updated.

The dynamic information may include dynamic data.

The processor 830 may provide the autonomous driving visibility information to at least one electric component provided in the vehicle. In addition, the processor 830 may also provide the autonomous driving visibility information to various applications installed in the systems of the vehicle 100.

The electric component refers to any device mounted on the vehicle 100 and capable of performing communication, and may include the components 120 to 700 described above with reference to FIG. 7. For example, the object detecting apparatus 300 such as a radar or a LiDAR, the navigation system 770, the vehicle operating apparatus 600, and the like may be included in the electric components.

In addition, the electric component may further include an application that may be executed by the processor 830 or a module that executes the application.

The electric component may perform its own function based on the autonomous driving visibility information.

The autonomous driving visibility information may include a lane-based path and the position or location of the vehicle 100, and may include dynamic information including at least one object to be sensed by the electric component. The electric component may reallocate resources to sense an object corresponding to the dynamic information, determine whether the dynamic information matches sensing information sensed by the electric component itself, or change a setting value for generating sensing information.

The autonomous driving visibility information may include a plurality of layers, and the processor 830 may selectively transmit at least one of the layers according to an electric component that receives the autonomous driving visibility information.

In detail, the processor 830 may select at least one of the plurality of layers included in the autonomous driving visibility information, based on at least one of a function that is being executed by the electric component and a function that is expected to be executed by the electric component. The processor 830 may transmit the selected layer to the electric component, and the unselected layers may not be transmitted to the electric component.

The processor 830 may receive external information generated by an external device, which is located within a predetermined range with respect to the vehicle, from the external device.

The predetermined range refers to a distance at which the second communication module 814 may perform communication, and may vary according to performance of the second communication module 814. When the second communication module 814 performs V2X communication, a V2X communication-available range may be defined as the predetermined range.

Furthermore, the predetermined range may vary according to an absolute speed of the vehicle 100 and/or a relative speed with the external device.

The processor 830 may determine the predetermined range based on the absolute speed of the vehicle 100 and/or the relative speed with the external device, and permit the communication with external devices located within the determined predetermined range.

Specifically, based on the absolute speed of the vehicle 100 and/or the relative speed with the external device, external devices that may perform communication through the second communication module 914 may be classified into a first group or a second group. External information received from an external device included in the first group is used to generate dynamic information, which will be described below, but external information received from an external device included in the second group is not used to generate the dynamic information. Even when external information is received from the external device included in the second group, the processor 830 ignores the external information.

The processor 830 may generate dynamic information related to an object to be sensed by at least one electric component provided in the vehicle based on the external information, and match the dynamic information with the autonomous driving visibility information.

For example, the dynamic information may correspond to the fourth layer described above with reference to FIGS. 11A and 11B.

As described above with reference to FIGS. 11A and 11B, the path providing device 800 may receive the ADAS MAP and/or the LDM data. Specifically, the path providing device 800 may receive the ADAS MAP from the telematics communication device 910 through the first communication module 812, and the LDM data from the V2X communication device 930 through the second communication module 814.

The ADAS MAP and the LDM data may be provided with a plurality of layers each having the same format. The processor 830 may select at least one layer from the ADAS MAP, select at least one layer from the LDM data, and generate the autonomous driving visibility information including the selected layers.

For example, after selecting first to third layers from the ADAS MAP and selecting a fourth layer from the LDM data, one autonomous driving visibility information may be generated by aligning those four layers into one. In this case, the processor 830 may transmit a refusal message for refusing the transmission of the fourth layer to the telematics communication device 910. This is because receiving partial information excluding the fourth layer uses less resources of the first communication module 812 than receiving all information including the fourth layer. By aligning part of the ADAS MAP with part of the LDM data, complementary information may be utilized.

In some examples, after selecting the first to fourth layers of the ADAS MAP and selecting the fourth layer of the LDM data, one autonomous driving visibility information may be generated by aligning those five layers into one. In this case, priority may be given to the fourth layer of the LDM data. If the fourth layer of the ADMS MAP includes information which is inconsistent with the fourth layer of the LDM data, the processor 830 may delete the inconsistent information or correct the inconsistent information based on the LDM data.

The dynamic information may be object information for guiding a predetermined object. For example, the dynamic information may include at least one of position coordinates for guiding the position of the predetermined object, and information guiding a shape, size, and kind of the predetermined object.

The predetermined object may refer to an object that disturbs driving in a corresponding lane among objects that may be driven on a road.

For example, the predetermined object may include a bus stopped at a bus stop, a taxi stopped at a taxi stand or a truck from which articles are being put down.

As another example, the predetermined object may include a garbage truck that travels at a predetermined speed or slower or a large-sized vehicle (e.g., a truck or a container truck, etc.)

that is determined to obstruct a driver's vision.

As another example, the predetermined object may include an object notifying an accident, road damage or repair.

As described above, the predetermined object may include all kinds of objects blocking a lane so that driving of the vehicle 100 is impossible or interrupted. The predetermined object may correspond to an icy road, a pedestrian, another vehicle, a construction sign, a traffic signal such as a traffic light, or the like that the vehicle 100 should avoid, and may be received by the path providing device 800 as the external information.

The processor 830 may determine whether or not the predetermined object guided by the external information is located within a reference range based on the driving path of the vehicle 100.

Whether or not the predetermined object is located within the reference range may vary depending on a lane in which the vehicle 100 is traveling and a position where the predetermined object is located.

For example, external information for guiding a sign indicating the construction on a third lane 1 km ahead of the vehicle while the vehicle is traveling in a first lane may be received. If the reference range is set to 1 m based on the vehicle 100, the sign is located outside the reference range. This is because the third lane is located outside the reference range of 1 m based on the vehicle 100 if the vehicle 100 is continuously traveling in the first lane. In some implementations, if the reference range is set to 10 m based on the vehicle 100, the sign is located within the reference range.

The processor 830 may generate the dynamic information based on the external information when the predetermined object is located within the reference range, but may not generate the dynamic information when the predetermined object is located outside the reference range. That is, the dynamic information may be generated only when the predetermined object guided by the external information is located on the driving path of the vehicle 100 or is within a reference range that may affect the driving path of the vehicle 100.

The path providing device may generate the autonomous driving visibility information by integrating information received through the first communication module and information received through the second communication module into one, which may result in generating and providing optimal autonomous driving visibility information capable of complementing different types of information provided through such different communication modules. This is because information received through the first communication module cannot reflect information in real time but such limitation may be complemented by information received through the second communication module.

Furthermore, when there is information received through the second communication module, the processor 830 controls the first communication module so as not to receive information corresponding to the received information, so that the bandwidth of the first communication module may be used less than that used in the related art. That is, the resource usage of the first communication module may be minimized.

Hereinafter, a path providing device which may include at least one of those components described above, and a method of controlling the same will be described in more detail with reference to the accompanying drawings.

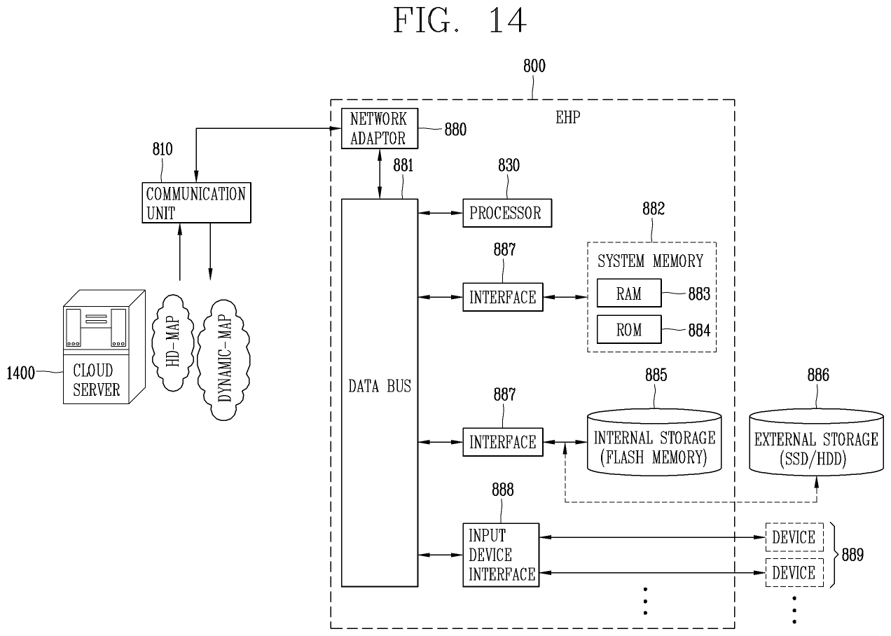

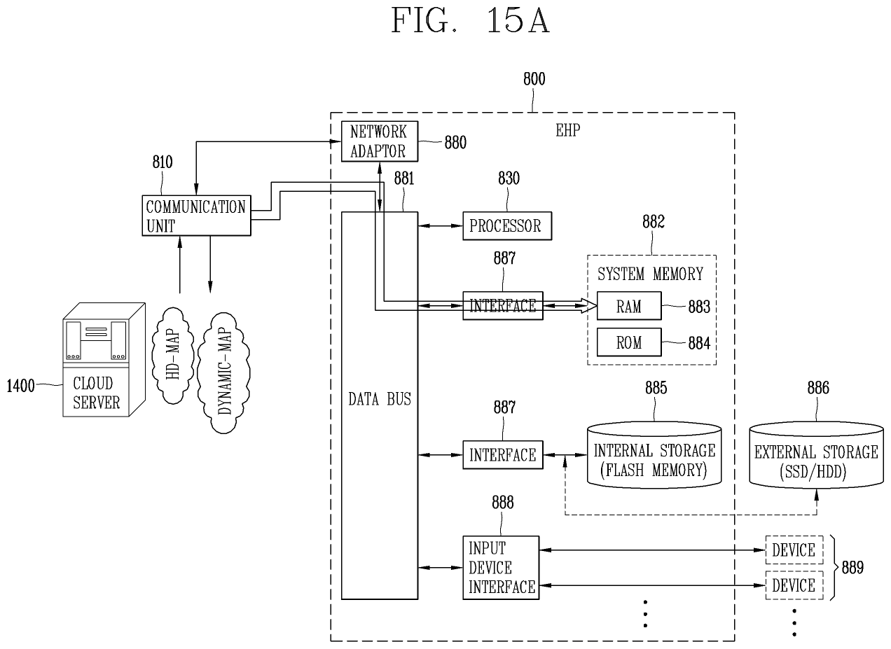

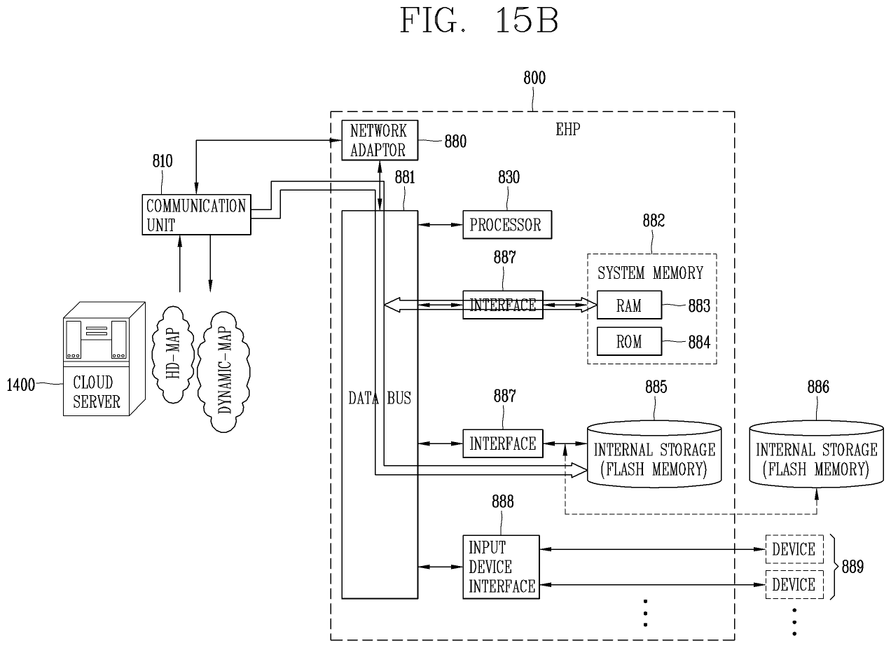

FIG. 14 is a conceptual view illustrating an example of a memory, and FIGS. 15A and 15B are conceptual views illustrating example methods for storing data received in a path providing device into one or more memory devices.

In some implementations, a path providing device may include a memory 882, 885 for storing information used to estimate or update an optimal path. For example, the memory 882, 885 may be non-transitory memory devices configured to store program instructions and data.

The information used to estimate or update the optimal path may include at least one of map information, sensing information, dynamic information, and autonomous driving visibility information, and may also include the optimal path itself.

The memory may include a plurality of memories 882 and 885 for storing information used to estimate or update the optimal path based on types of information in different storage spaces.

Here, the different storage spaces may indicate different memories.

As described above, the path providing device 800 may include the communication unit 810, but as illustrated in FIG. 14, the communication unit 810 may be provided outside the path providing device 800 so as to perform communication with the path providing device 800 in a wired manner (e.g., Controller Area Network (CAN) communication).

When the communication unit 810 exists outside the path providing device, the communication unit 810 may also be the communication apparatus 400 existing in the vehicle.

The path providing device 800 may include a network adapter 880 that receives information (for example, map information or dynamic information) transmitted from a server 1400 through the communication unit 810.

The network adapter 880 may serve to convert a signal corresponding to the information received by the communication unit 810 into a signal that may be processed by the path providing device 800.

The network adapter 880 may be connected to a data bus 881 serving as a path for transmitting information to various modules included in the path providing device 800.

The data bus 881 may transmit the information converted by the network adapter 880 to at least one of the various components (e.g., the processor 830, the first memory 883, the second memory 885, etc.) included in the path providing device 800 and the electric components provided in the vehicle.

That is, the data bus 881 may be a path for transmitting a signal of information (or data) received by the network adapter 880 to a module (or processing device) included in the path providing device 800.

In this case, the data bus 881 may transmit data (or information) through CAN communication, or transmit such data (or information) to at least one of the components provided in the path providing device 800 and the electric components provided in the vehicle through a circuit provided on a printed circuit board.

The processor 830 connected to the data bus 881 may control or command the components included in the path providing device 800 or receive information (or data) from the components through the connected data bus 881.

Referring back to FIG. 14, the memory included in the path providing device 800 may include a system memory 882 and an internal storage (or flash memory) 885.

The system memory 882 may include a Random Access Memory (RAM) 883 and a Read Only Memory (ROM) 884.

The RAM 883 is a memory capable of loading memorized information or memorizing other information. The RAM 883 may be used as a main memory of a computer, or may be used to temporarily load an application program, temporarily store data, and the like. The RAM 883 is a volatile memory that loses recorded information when power is cut off. The RAM 883 is configured to temporarily store data while power is supplied. In this specification, the RAM 883 is referred to as a first memory 883.

The ROM 884 may refer to a memory that may read data at a high speed but cannot write (record) it again. For example, the ROM 884 means a read-only memory. The ROM is a non-volatile memory which does not lose information even when power is cut off. However, since the ROM may read data but cannot change data, the ROM is not included as a memory controlled by the path providing device.

The internal storage (flash memory) 885 refers to a non-volatile memory in which stored information is not erased even when power is cut off. The internal storage 885 may be included in the path providing device 800, and information stored in the internal storage 885 may be maintained without disappearing even by low power consumption or even when power is off.

The internal storage 885 may have not only the advantage of the ROM that may retain stored information as it is even when power supply is stopped, but also the advantage of the RAM that allows free input and output of information. In addition, the internal storage 885 is advantageous in view of fast speed and low power consumption. The internal storage 885 is configured to store data even power supply is stopped, and is referred to as a second memory 885 in this specification. For example, the second memory 885 may be a non-volatile memory device configured to retain stored information while power is turned off and allow a user to carry the second memory 885 from one device to another without providing power to the second memory 885.

The processor 830 of the path providing device 800 may further store information in an external storage 886 provided outside the path providing device 800. The external storage 886 may refer to an SDD/HDD having a large storage capacity.

The external storage 886 may be provided within the vehicle although it is located outside the path providing device 800, so as to perform wired communication (or CAN communication). In addition, the external storage 886 may be a memory 140 provided in the vehicle. The external storage 886 is referred to as an external storage in this specification.

The memories 882 and 885 may refer to the storage part 832 of the processor 830 and the calculation part 834 of the processor 830 described with reference to FIG. 8.

For example, the system memory 882 may refer to the calculation part 834 of the processor 830, and the internal storage 885 may refer to the storage part 832 of the processor 830.

In summary, the path providing device 800 may include the memory. The memory may include the first memory (RAM) 883 that temporarily stores data while power is supplied, and the second memory (internal storage, flash memory) 885 that stores data even though power supply is stopped.

The first memory 883 and the second memory 885 may be connected to the data bus 881 that is configured to transmit information received through the communication unit 810 to the memory.

In this case, as illustrated in FIG. 14, each of the first memory 883 and the second memory 885 may be connected to the data bus 881 through an interface 887.

The interface 887 may be a path connecting the data bus 881 and the components (for example, the first memory and the second memory) included in the path providing device 800, and may be a wire supporting CAN communication or a circuit provided on a printed circuit board.

In addition, the path providing device 800 may further include an input device interface 888 for transmitting information transmitted through the data bus 881 to an electric component 889 provided in the vehicle. The input device interface 888 may be the interface unit 820 described above.

The second memory 885, which is a flash memory, may have a relatively high processing speed and have an appropriate capacity.

For example, the second memory 885 may be configured such that a processing speed is a first speed and a storage capacity is a first capacity.

In this case, as illustrated in FIG. 14, the data bus 881 may be connected through the interface 887 to the external storage 886 (external storage, SSD/HDD) which is configured such that the processing speed is a second speed slower than the first speed and a storage capacity is a second capacity larger than the first capacity.

The external storage (SDD/HDD) may be configured to have a processing speed slower than that of the second memory 885 (flash memory) included in the path providing device but have a storage capacity larger than that of the second memory 885.

In some implementations, data having a large capacity may be stored in the external storage, and data having a small capacity and for fast processing may be stored in the first or second memory.

The second memory 885 may be divided into a plurality of storage spaces to store different types of data. The plurality of storage spaces may store a plurality of layers forming map information in a dividing manner.

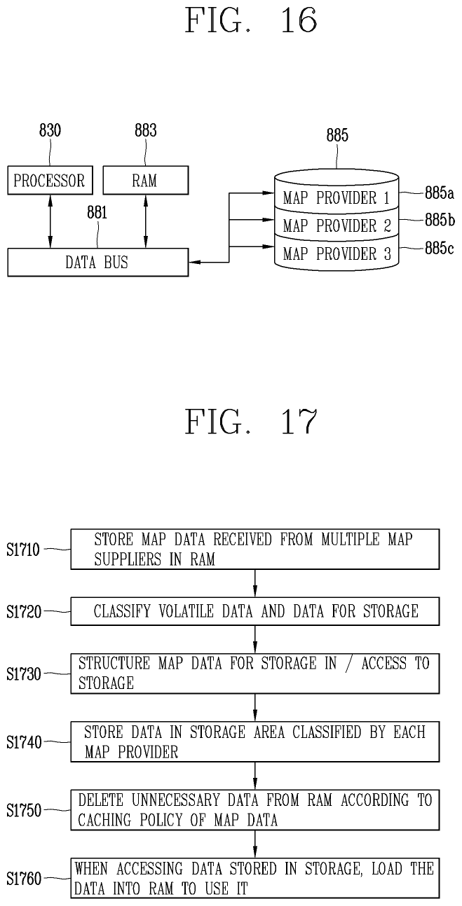

For example, as illustrated in FIG. 16, the second memory 885 may be partitioned (or divided) into a plurality of storage spaces. This means that an internal storage space of the second memory 885 is divided into several storage spaces, and a concept of a component or a partition may be introduced.

In detail, information included in a first layer of the plurality of layers may be stored in a first storage space (e.g., 885a) among the plurality of storage spaces 885a, 885b, and 885c.

In addition, information included in a second layer different from the first layer among the plurality of layers may be stored in a second storage space (e.g., 885b) different from the first storage space among the plurality of storage spaces.

For example, a first layer (HD map) of a plurality of layers forming map information may be stored in the first storage space 885a, and a second layer (dynamic information) of the plurality of layers forming the map information may be stored in the second storage space 885b. In addition, the first memory 883 and the second memory 885 may be configured to allow bidirectional data transmission through the data bus 881.

That is, the first memory 883 and the second memory 885, under the control of the processor 830, may not only store information received from the server 1400 through the communication unit 810, but also perform bidirectional data transmission of loading information stored in the second memory 885 to the first memory 883 or the processor 830 or loading information stored in the first memory 883 to the processor 830. In addition, the processor 830 may also not only store data in the first memory 883, but also transfer information stored in the first memory 883 to the second memory 885 so that the information is stored in the second memory 885.

Hereinafter, description will be given in more detail of a method of processing information received through the communication unit 810 (e.g., map information received from the server 1400, or information received from an external device (e.g., another vehicle) existing within a predetermined distance from the vehicle) using the memory in the path providing device, with reference to the accompanying drawings.

The processor 830 may temporarily store and then delete map information received from the server 1400 in the first memory 883 or store the map information in the second memory 885 for a long time, according to a type of the map information. In addition, in preparation of a case where communication through the communication unit 810 is impossible, the processor 830 may store large map information even in the external storage 886.

Referring to FIG. 15A, the processor 830 may store map information received through the communication unit 810 in a specific area of the first memory 883 (RAM). In this case, when receiving the map information from the server 1400, the processor 830 may sequentially receive a plurality of partial map information.

Here, the plurality of partial map information may refer to that the map information is divided into the plurality of partial map information. The plurality of partial map information may refer to map information generated in tile unit (i.e., map information tile) described above.

Each of the plurality of partial map information may include a plurality of layers, and the plurality of layers may have the same size (that is, cover the same area).

That is, the partial map information may refer to map information having a smaller size than the map information, and as illustrated in FIGS. 12A and 12B, may refer to map information in tile unit covering a predetermined area, respectively.

The processor 830 may sequentially receive the plurality of partial map information from the server 1400 through the communication unit 810. In some cases, the processor 830 may preferentially store the plurality of partial map information (i.e., map information tiles) sequentially in the first memory 833.

Subsequently, the processor 830 may allocate a specific area of the first memory 883 for caching the map information (the plurality of partial map information) and store the map information in the allocated specific area. In this case, the caching may refer to that the processor 830 temporarily stores map information (partial map information) having a high frequency of use in the first memory 883 having a fast processing speed in order to use such data quickly. The processor 830 may perform various operations related to EHP (e.g., a process of generating/updating an optimal path or generating/updating autonomous driving visibility information) using the map information stored in the first memory 883, or generate forward path information (optimal path or MPP) and store the generated forward path information in the first memory 883.

In addition, the processor 830 may transmit EHP-related information (e.g., optimal path or autonomous driving visibility information) stored in the first memory 883 to an electric component or application provided in the vehicle through an external interface, and delete the EHP-related information from the first memory 883. At this time, the deletion may be sequentially carried out according to a caching policy.

In some examples, the path providing device 800 may receive map information from a plurality of map provider servers (or map information providers) through the communication unit 810. In this case, the path providing device may receive a plurality of map information, and the plurality of map information may be different map information produced by different map information providers.

As the map information providers are different, the plurality of map information may be different in type, format, style, accuracy, focused portion (e.g., whether highway map information is detailed or downtown map information is detailed, etc.) of information included.

The processor 830 may receive map information from a plurality of map provider servers (or a plurality of map information providers) through the communication unit 810, and the reception may be selectively carried out.

As illustrated in FIG. 15B, the processor 830 may preferentially (primarily) store the received map information in the first memory 883 (RAM).

The processor 830 may classify the map information stored in the first memory 883 into volatile data and storage data according to an attribute of the map information. The processor 830 may then determine according to a result of the classification whether to store the map information stored in the first memory 883 temporarily in the first memory 883 or by moving to the second memory 885.

For example, the attribute of the map information may include whether the map information is an HD map, whether the map information is dynamic information to be updated, or the like, and may differ depending on a type of layer included in the map information among a plurality of layers.

Afterwards, the processor 830 may classify the received map information into volatile data and storage data according to the attribute of the map information stored in the first memory 883. The processor 830 may then temporarily store the received map information in the first memory 883 and then delete the temporarily stored map information or may store the received map information in the second memory 885, according to a result of the classification.

In addition, when a capacity of the received map information is larger than a preset size, the processor 830 may also store the received map information in the external storage 886 other than the second memory 885.

FIG. 16 is a conceptual view illustrating a memory having a plurality of storage spaces. As illustrated in FIG. 16, the memory (the second memory 885) may be divided into a plurality of storage spaces 885a, 885b, and 885c.

When the processor 830 receives a plurality of map information produced by different map information companies (or servers of map information companies or servers of a plurality of map providers) through the communication unit 810, the processor 830 may store the plurality of map information in the plurality of storage spaces 885a, 885b, and 885c in a dividing manner. Specifically, the processor 830 may store first map information received from a first map information provider in the first storage space 885a of the plurality of storage spaces.

Also, the processor 830 may store second map information received from a second map information provider different from the first map information provider in the second storage space 885b different from the first storage space among the plurality of storage spaces. As described above, the path providing device 800 may receive map information from a server. Here, the server may refer to a map information company (or a server used by a map information company, a map provider, or a server of a map provider) that produces (or supplies) map information.

The server may also refer to a server of a mobile communication company that provides mobile communication network services, in terms of transmitting map information.

In this case, a map information company (a map supplier or a map provider) may transmit map information to a server of a mobile communication company constructing a mobile communication network, and the server of the mobile communication company may transfer the map information to the path providing device 800 through the communication unit 810.

When there are a plurality of map providers and one mobile communication network, each of the plurality of map providers may transmit map information to a server constructing the one mobile communication network (a server of a mobile communication company).

The server constructing the mobile communication network may transmit the plurality of map information received from the plurality of map providers to the communication unit 810. The structure described above should be understood to include that a map provider directly provides map information to the communication unit 810 using a predetermined mobile communication network.

The processor 830 may receive different types of map information from different map providers. For example, the processor 830 may receive first map information including detailed highway information from a first map provider, and second map information including city information from a second map provider.

Here, receiving the different types of map information may also include the meaning of selectively receiving a plurality of layers forming the map information.

For example, the processor 830 may receive a first layer including highway information from a first map provider and a second layer including landmark information from a second map provider.

The processor 830 may divide (partition) the storage space of the second memory 885 into a plurality of storage spaces.

The processor 830 may determine storage spaces for storing a plurality of map information based on capacities of map information received.

For example, first map information having the largest capacity (first capacity) among a plurality of map information may be stored in a first storage space having the largest storage capacity among a plurality of storage spaces.

Also, second map information having the second largest capacity (a second capacity smaller than the first capacity) among the plurality of map information may be stored in a second storage space having the second largest storage capacity among the plurality of storage spaces.

In some examples, as illustrated in FIG. 16, the processor 830 may allocate a storage space for each map information provider.

For example, the processor 830 may store at least one piece of information (or a plurality of pieces of information) received from a first map provider in a first storage space of the memory 885 and store at least one piece of information (or a plurality of pieces of information) received from a second map provider in a second storage space of the memory 885.

That is, the processor 830 may determine a storage space of a memory to store map information according to a type or capacity of each map information, or according to a map provider providing (transmitting) the map information.

The plurality of storage spaces formed in the memory 885 may all have the same capacity, or at least two of the plurality of storage spaces may have different capacities.

In addition, the capacities of the plurality of storage spaces may be changed by the control of the processor 830.

As described above, the memory included in the path providing device 800 may include the first memory (RAM) 883 that temporarily stores data while power is supplied, and the second memory (flash memory) 885 that stores data even though power supply is stopped.

Hereinafter, a method of storing map information received through the communication unit 810 in the first and second memories and deleting the stored map information will be described in more detail with reference to the accompanying drawings.

FIGS. 17, 18, 19 are conceptual views illustrating example methods for controlling a memory.

In some implementations, referring to FIG. 17, the processor 830 may store map data (a plurality of map information) received from a plurality of map providers (map providing companies) in the RAM (S1710).

For example, the processor 830 may preferentially store information (map information) received through the communication unit 810 in the first memory (RAM) 883.

Thereafter, the processor 830 may classify the information stored in the first memory into volatile data and storage data based on a type of the information stored in the first memory (S1720).

For example, the processor 830 may delete the information from the first memory 883 or move the information to the second memory 885 (flash memory) for storage, based on the type of the information stored in the first memory 883.

In some examples, the processor 830 may store information (map information), which has been preferentially stored in the first memory 883, in the second memory 885 and may structure the received information (map information) to be accessible (S1730). For example, the structuring may refer to dividing the information into a plurality of layers as illustrated in FIGS. 11A and 11B, or generating autonomous driving visibility information as illustrated in FIG. 10.

In some implementations, the processor 830 may divide (partition) the second memory 885 into a plurality of storage spaces. Here, dividing (partitioning) the second memory into the plurality of storage spaces may refer to performing partitioning.

The processor 830 may allocate the plurality of storage spaces for each map provider.

The processor 830 may store information (map information) received from a map provider that has transmitted the information (map information) through the communication unit 810 in an allocated storage space for the information. That is, the processor 830 may store information (map information) in a storage space classified for each map provider (S1740). As another example, the processor 830 may store received map information in a different storage space based on a capacity or type of the received map information.

Thereafter, the processor 830 may delete unnecessary information existing in the first memory 883 according to a caching policy of the map information (S1750).

For example, the processor 830 may delete data, which has been moved (copied) from the first memory 883 to the second memory 885 for storage, and data, which is determined to have been completely used for generating/updating an optimal path or autonomous driving visibility information in the first memory 883, from the first memory 883.

In addition, when loading (or accessing) data (map information) stored in the second memory 885, the processor 830 may load the data (map information) to the first memory 883 (RAM) for use (S1760).

For example, a plurality of map information may be stored in the second memory 885. In this state, the processor 830 may divide a driving road to a destination into a plurality of path sections based on characteristics of the road, and determine map information to be used for each divided path section based on the characteristics of the road.

Thereafter, the processor 830 may load map information to be used for each path section from the second memory 885 to the first memory 883 so as to generate an optimal path (i.e., MPP) in each path section.

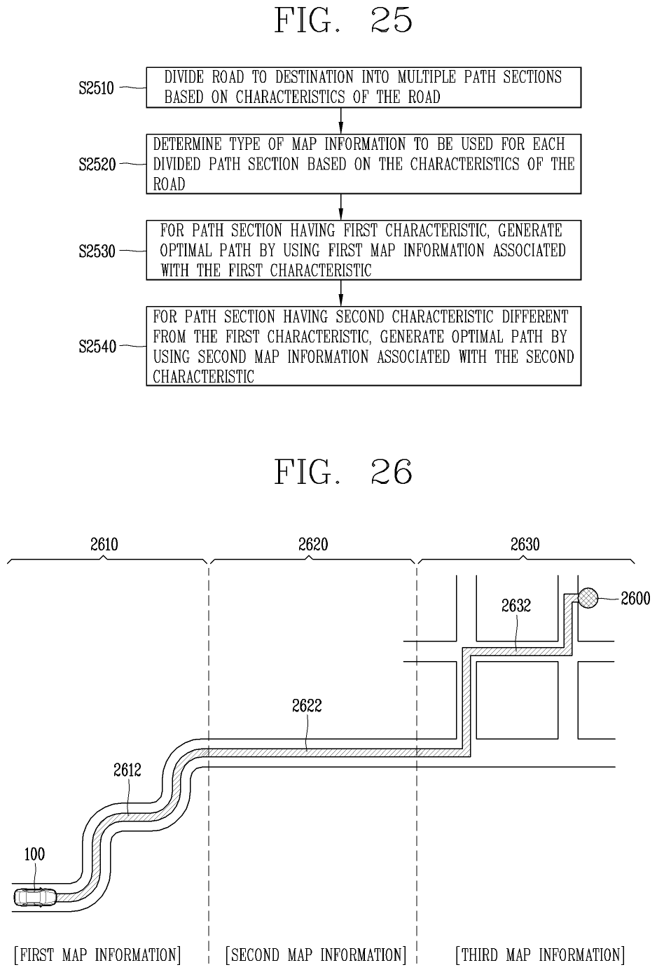

The related contents will be described later in detail with reference to FIGS. 25 and 26. In some examples, the path providing device 800 may receive various types of map information through the communication unit 810, and store the received map information in the memory in various ways.

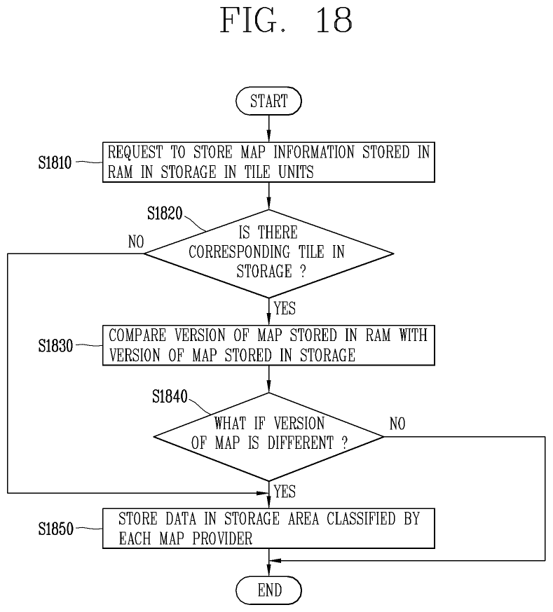

For example, referring to FIG. 18, the processor 830 may receive map information from the server 1400 through the communication unit 810. At this time, the map information, as described above, may be map information or partial map information received in tile units.

The processor 830 may request to store map information stored in the first memory (RAM) 883 in the second memory 885 in tile units (or in units of partial map information) (S1810).

In this case, the processor 830 may determine whether there is map information (or map information in tile units or partial map information) that has been requested to be stored in the second memory 885 (S1820).

When there is the map information requested to be stored in the second memory 885, the processor 830 may compare a version of the map information, which is stored in the first memory 883 and has been requested to be stored in the second memory 885, with a version of map information pre-stored in the second memory 885 (S1830).

At this time, when the versions of the map information are different (S1840), the processor 830 may store the storage-requested map information in the second memory 885 (S1850).

When there is no map information requested to be stored in the second memory 885 in step S1820, the processor 830 may store the storage-requested map information in the second memory 885.

In some implementations, when the versions of the map information are the same as each other, it means that the map information requested to be stored in the second memory 885 is already stored in the second memory 885. When the versions of the maps are the same, the processor 830 may delete the map information stored in the first memory 883.

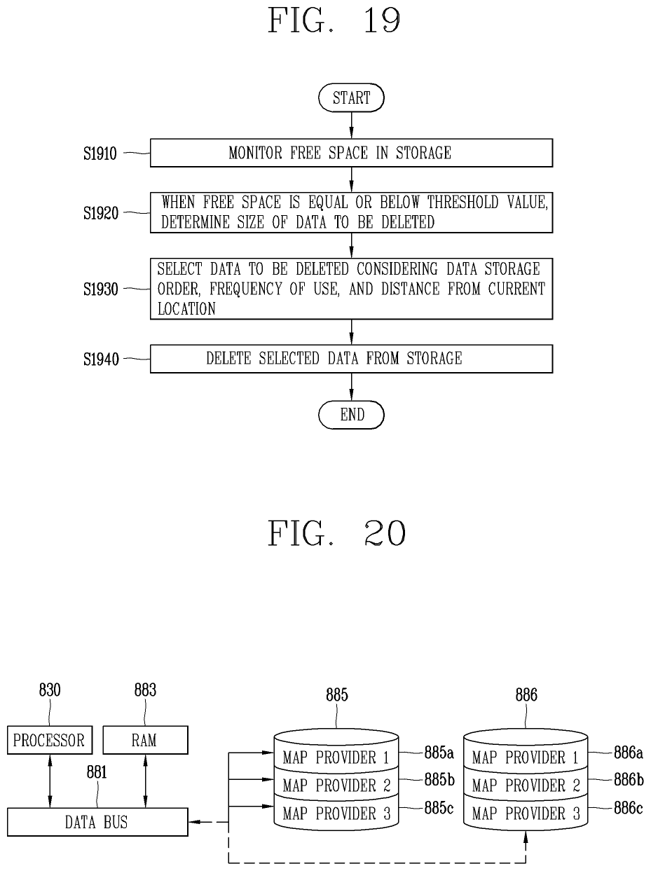

Referring to FIG. 19, the processor 830 may monitor a storage-available space (i.e., vacant space) of the second memory 885 (S1910).

In this case, when the vacant space is smaller than or equal to a threshold value, the processor 830 may determine a capacity (or size) of data to be deleted (S1920).

Specifically, the processor 830 may select (determine) data (map information) to be deleted, in consideration of at least one of a data storage order, a frequency of use, a distance between a current position of the vehicle and a position of an area included in the data (map information) (S1930).

For example, when the vehicle is currently located at a first position and there is map information (data) corresponding to an area of a second position spaced apart from the first position by a predetermined distance or more, the processor 830 may select the map information corresponding to the area of the second position as data to be deleted.

Thereafter, the processor 830 may delete the selected data (map information) from the second memory 885 to secure (expand) the storage-available space of the second memory 885 (S1940).

In some examples, the processor 830 may store data in different ways according to a capacity of the second memory 885.

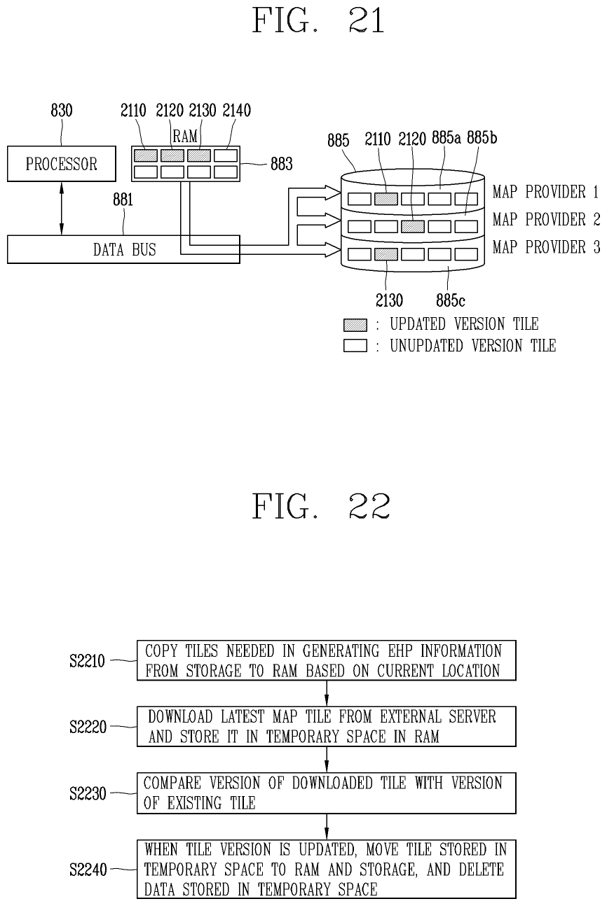

FIGS. 20 and 21 are conceptual views illustrating example methods for storing map information in a memory.

For example, when a capacity of the second memory 885 is greater than or equal to a predetermined size (that is, if enough), the processor 830 may divide (partition) the second memory 885 into a plurality of storage spaces without having to use a separate external storage 886, and store map information in the divided plurality of storage spaces.

In this case, as described above, the processor 830 may store map information in a different storage space for each company producing map information.

In some implementations, when the capacity of the second memory 885 is smaller than the predetermined size (that is, if not enough), the processor 830 may process the map information in the following manner.

In some implementations, the processor 830 may store map information within a predetermined radius based on the current position of the vehicle in the second memory 885, and immediately delete unnecessary data by determining validity of stored map information based on the current position of the vehicle.

In some implementations, the processor 830 may store only a basic layer, which is necessary for generating an optimal path among a plurality of layers included in map information, in the second memory 885.

Here, the basic layer may be a layer including road information and lane information necessary for generating an optimal path.

Subsequently, the processor 830 may receive the other layers except for the basic layer from a server through the communication unit 810 in real time, store the received layers in the first memory (RAM) 883, and then update the optimal path or generate/update autonomous driving visibility information.

The second memory may also be divided into a plurality of storage spaces, and the plurality of layers of the map information may be stored in the plurality of storage spaces, respectively.

In this case, the processor may determine a type of a memory in which each layer is stored and a storage space in the second memory based on at least one of a type and a capacity of each of the plurality of layers.

For example, the processor 830 may determine a type of a memory (first memory, second memory or external storage) in which each layer is to be stored and a storage space in the second memory, based on at least one of a type of each of the plurality of layers (i.e., whether a layer is a basic layer) and a capacity of each layer.

In some implementations, as illustrated in FIG. 20, the processor 830 may store map information including a current position of the vehicle and map information within a predetermined distance from the current position in the second memory 885, and store map information out of the predetermined distance in the external storage 886.

In some examples, when information received through the communication unit is map information having a predetermined capacity or more, the processor 830 may store the map information having the predetermined capacity or more in the external storage which is provided in the vehicle and located outside the path providing device.

In some cases, as illustrated in FIG. 20, the external storage 886 may be divided into a plurality of storage spaces 886a, 886b, and 886c. The external storage 886, like the second memory 885, may store map information in a different storage space based on a capacity of each map information, or store map information in the same storage space for each map provider producing the map information.

In some examples, map information may be pre-stored in the second memory 885 or the external storage 886 since a product was first released. This is for the processor 830 to generate an optimal path or autonomous driving visibility information even without receiving separate map information from the communication unit 810.

In some cases, the processor 830 may load map information pre-stored in the second memory 885 into the first memory 883 to generate an optimal path or autonomous driving visibility information.

In some implementations, when the processor 830 receives the latest version of map information (or map information in tile units) from the server through the communication unit 810, the processor 830 may preferentially store the received map information in the first memory 883.

Thereafter, as illustrated in FIG. 21, the processor 830 may determine whether the received pieces of map information are present in the second memory 885.

If the received pieces of map information is not present in the second memory 885, the processor 830 may move the received pieces of map information from the first memory 883 to the second memory 885 and store the received pieces of map information in the second memory 885.

When the received pieces of map information already exist in the second memory 885, the processor 830 may compare versions of the received pieces of map information 2110, 2120, 2130, and 2140 with versions of pre-stored map information.

Then, when the versions are different (for example, when the versions of the received pieces of map information 2110, 2120, and 2130 are higher), the processor 830 may move the pieces of map information 2110, 2120, and 2130 stored in the first memory 883 into the second memory 885 and store them in the second memory 885.

If the version of the received map information 2140 is the same as that of the map information pre-stored in the second memory 885, the processor 830 may delete the received map information 2140 from the first memory 883.

In some examples, when the external storage 886 is present, the processor 830 may also store the map information stored in the second memory 885 in the external storage 886 in the same manner. Subsequently, even if the map information is deleted from the second memory 885, the processor 830 may generate an optimal path or autonomous driving visibility information using the map information, which is the same as the deleted map information, stored in the external storage 886.

FIGS. 22, 23, and 24 are conceptual views illustrating example methods for controlling a memory.

Referring to FIG. 22, the processor 830 may copy map information (partial map information or map information in tile units), which is necessary for generating an optimal path or autonomous driving visibility information (EHP information) based on a current position of the vehicle, from the second memory 885 to the first memory 883 (S2210).

In addition, the processor 830 may receive the latest version of map information tiles (i.e., the latest version of map information or partial map information) from an external server and store the received map information tiles in the first memory 883 (S2220).

The processor 830 may compare the version of the map information received from the external server with a version of the map information copied to the first memory (S2230).

Then, when the version of the map information received from the external server is higher, the processor 830 may update the map information copied to the first memory 883 and the map information stored in the second memory 885 using the received map information. Then, the processor 830 may delete the map information (data) stored in the first memory 883 (S2240).

The processor 830 may generate the autonomous driving visibility information using the received map information.

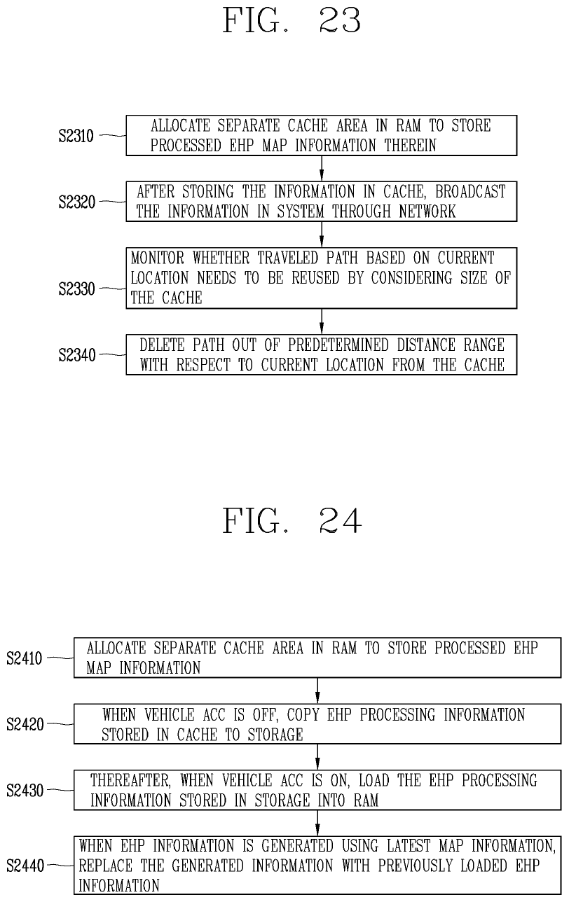

In this case, referring to FIG. 23, the processor 830 may store the generated autonomous driving visibility information (i.e., processed EHP map information) by allocating a separate cache area of the first memory 883 (S2310).

In addition, the processor 830 may broadcast the autonomous driving visibility information stored in the cache area to a system (i.e., an electric component provided in the vehicle) through the communication unit 810 (S2320).

At this time, the processor 830 may monitor whether it is necessary to reuse a path (also, autonomous driving visibility information) already passed (or used) based on a current position, on the basis of a size of the cache (i.e., the cache area of the first memory 883) (S2330).

Thereafter, the processor 830 may delete a path (also, autonomous driving visibility information), which is out of a predetermined distance range based on the current position, from the cache area of the first memory 883 (S2340).

Through this configuration, the present disclosure may perform fast processing by storing autonomous driving visibility information in the first memory 883, and also ensure a storage capacity of the first memory by deleting the stored autonomous driving visibility information after broadcasting the autonomous driving visibility information to an electric component equipped in the vehicle.

In some implementations, referring to FIG. 24, the processor 830 may store the processed EHP map information (i.e., autonomous driving visibility information) in a separately allocated cache area of the first memory 883 (S2410).

Subsequently, when an Adaptive Cruise Control (ACC) in an ON state is turned off, the processor 830 may move the autonomous driving visibility information stored in the first memory 883 to be stored in the second memory 885 (S2420). That is, because the autonomous driving visibility information should be used at a fast processing speed when the ACC function is performed, the autonomous driving visibility information is stored in the first memory 883. In some implementations, the autonomous driving visibility information is used at a slow processing speed or is not used when the ACC function is turned off.

Thereafter, when the ACC function of the vehicle is executed again (ON), the processor 830 may load the autonomous driving visibility information stored in the second memory 885 back into the first memory 883. (S2430).

When the generation of the EHP information (autonomous driving visibility information) is completed using the latest version of the map information received through the communication unit 810, the processor 830 may replace the autonomous driving visibility information loaded to the first memory 883 with the generated autonomous driving visibility information (S2440).

Here, the replacement may mean that the autonomous driving visibility information loaded to the first memory 883 is deleted and the newly-generated autonomous driving visibility information is stored (or loaded) in the first memory 883.

Hereinafter, a method of generating an optimal path using map information stored in a memory will be described in more detail with reference to the accompanying drawings.

FIGS. 25 and 26 are diagrams illustrating example methods for generating an optimal path (route) using map information stored in a memory.

Referring to FIG. 25, the processor 830 may divide a driving road to a destination into a plurality of path sections based on characteristics of the road (S2510).

In addition, the processor 830 may determine a type of map information to be used for each of the divided path sections based on the characteristics of the road (S2520).

In detail, the processor 830 may generate an optimal path for a path section having a first characteristic by using first map information associated (linked) with the first characteristic (S2530).

Also, the processor 830 may generate an optimal path for a path section having a second characteristic different from the first characteristic by using second map information associated with the second characteristic (S2540).

Here, the first map information and the second map information may be map information received from different entities (that is, different map information providers, map information companies, or map providers).

Each of the first map information and the second map information may be partial map information having a predetermined size and including the divided path section.

In this case, the plurality of map information may be stored in the second memory 885. In this state, the processor 830 may divide a driving road to a destination into a plurality of path sections based on characteristics of the road, and determine map information to be used for each divided path section based on the characteristics of the road.

Thereafter, the processor 830 may load map information to be used for each path section from the second memory 885 to the first memory 883 so as to generate an optimal path (i.e., MTV) in each path section.

That is, the first and second map information may refer to map information in tile units or partial map information described above.

As illustrated in FIG. 26, the processor 830 may determine a road on which the vehicle should travel based on a current position of the vehicle 100 and a position of a destination 2600. Thereafter, the processor 830 may divide the driving road to the destination into a plurality of path sections 2610, 2620, and 2630 based on the characteristics of the road.

For example, the first path section 2610 may refer to a national road with many curves, the second path section 2620 may refer to a highway, and the third path section 2630 may refer to a city street.

The processor 830 may generate an optimal path 2612 for the first path section 2610 having a first characteristic (e.g., the national road) by using first map information associated with the first characteristic.

Also, the processor 830 may generate an optimal path 2622 for the path section 2620 having a second characteristic (e.g., the highway) different from the first characteristic by using second map information associated with the second characteristic.

The processor 830 may generate an optimal path 2632 even for the third path section 2630 having a third characteristic by using third map information associated with the third characteristic.

That is, map information optimized (or detailed, compatible) according to a characteristic of a path section may vary depending on each map information provider. For example, in map information made by a first map information provider, the first map information associated with the first characteristic (national road) may be more detailed than that included map information produced by other map information providers.

In addition, in map information made by a second map information provider, the second map information associated with the second characteristic (i.e., the highway) may be more detailed than that included in map information made by other map information providers.

In this way, information related to a characteristic of a road may be associated with each map information.

The processor 830 may determine map information to be used in each path section based on a characteristic of a road associated with each map information and a characteristic of a road for each path section.

Thereafter, the processor 830 may generate an optimal path in each path section, in lane units, by using the determined map information.

In addition, the processor 830 may determine a path section including a current position of the vehicle among the divided path sections. The processor 830 may determine map information in the memory based on a characteristic of a road belonging to the determined path section. The processor 830 may estimate an optimal path in the determined path section, in lane units, by using the determined map information.

For example, when it is determined that the current position of the vehicle is included in the first path section 2610, the processor 830 may determine first map information, which is to be used for calculating the optimal path in the corresponding path section, in the memory based on the characteristic of the road belonging to the first path section 2610. The first map information may be map information associated with the characteristic (national road) of the road belonging to the first path section.

Thereafter, the processor 830 may estimate the optimal path 2612 in the first path section 2610 in lane units using the determined first map information.

Even when the current position of the vehicle 100 is in the second path section or the third path section, the above-described method may be equally/similarly applied.

In addition, when the vehicle has passed through a path section in which the map information loaded to the first memory 883 is used, the processor 830 may delete the loaded map information from the first memory 883.

As described above, in the state where map information used for generating an optimal path is loaded from the second memory 885 to the first memory 883, the processor 830 may generate an optimal path using the map information loaded to the first memory 883. This is for quickly generating/updating an optimal path while the vehicle is traveling.

In some implementations, when it is determined that the vehicle has passed through the path section in which the map information loaded to the first memory 883 is used, the processor 830 may delete the map information loaded to the first memory 883 from the first memory 883.

Hereinafter, effects of a path providing device and a path providing method thereof will be described.

First, the present disclosure may provide a path providing device including a memory optimized for generating or updating autonomous driving visibility information.

Second, the present disclosure may effectively store and delete information necessary to perform autonomous driving or lane-based path guidance, by using an optimized memory.

Third, the present disclosure may provide a path providing device that may efficiently process received information using a plurality of memories, and improve memory efficiency by storing or deleting information according to a type of information.

Fourthly, the present disclosure may provide a path providing device that may store different types of map information generated in different map providers separately by dividing a memory into a plurality of storage spaces, and may generate autonomous driving visibility information or an optimal path by loading optimized map information from the memory according to situations.

The present disclosure may be implemented as computer-readable codes (applications or software) in a program-recorded medium. The method of controlling the autonomous vehicle may be realized by a code stored in a memory or the like.

The computer-readable medium may include all types of recording devices each storing data readable by a computer system. Examples of such computer-readable media may include hard disk drive (HDD), solid state disk (SSD), silicon disk drive (SDD), ROM, RAM, CD-ROM, magnetic tape, floppy disk, optical data storage element and the like. Also, the computer-readable medium may also be implemented as a format of carrier wave (e.g., transmission via an Internet). The computer may include the processor or the controller. Therefore, it should also be understood that the above-described implementations are not limited by any of the details of the foregoing description, unless otherwise specified, but rather should be construed broadly within its scope as defined in the appended claims, Therefore, all changes and modifications that fall within the metes and bounds of the claims, or equivalents of such metes and bounds are therefore intended to be embraced by the appended claims.

What is claimed is:

1. A path providing device configured to provide path information to a vehicle, the device comprising:
a communication unit configured to receive map information from a server, the map information comprising a plurality of layers of data;
an interface unit configured to receive sensing information from one or more sensors disposed at the vehicle, the sensing information comprising an image received from an image sensor;
a processor configured to:
based on the sensing information, identify a lane in which the vehicle is located among a plurality of lanes of a road,
determine an optimal path for guiding the vehicle from the identified lane, the optimal path comprising one or more lanes included in the map information,
based on the sensing information and the optimal path, generate autonomous driving visibility information to be transmitted to at least one of an electric component disposed at the vehicle or the server, and
update the optimal path based on the autonomous driving visibility information and dynamic information related to a movable object located in the optimal path; and
a memory configured to store information used for determining or updating the optimal path, the memory comprising a plurality of memories configured to store the information used for determining or updating the optimal path in different storage spaces based on types of information to be stored.

2. The path providing device of claim 1, wherein the plurality of memories comprise:
a first memory configured to store first data based on power being supplied to the first memory; and
a second memory configured to retain second data while power is not supplied to the second memory.

3. The path providing device of claim 2, further comprising a data bus that is connected to the first memory and the second memory and configured to transmit the map information received through the communication unit to at least one of the first memory or the second memory.

4. The path providing device of claim 3, further comprising one or more interfaces that connect the data bus to the first memory and the second memory.

5. The path providing device of claim 4, wherein the second memory has a first processing speed and a first storage capacity, and
wherein the data bus is connected, through the one or more interfaces, to an external storage, the external storage having a second processing speed slower than the first processing speed and a second storage capacity greater than the first storage capacity.

6. The path providing device of claim 2, wherein the second memory is divided into a plurality of storage spaces that are configured to store different types of data, each of the plurality of storage spaces being configured to store one of the plurality of layers.

7. The path providing device of claim 6, wherein the plurality of storage spaces of the second memory comprise:
a first storage space configured to store a first type of data corresponding to a first layer among the plurality of layers; and
a second storage space configured to store a second type of data corresponding to a second layer among the plurality of layers, the second layer being different from the first layer.

8. The path providing device of claim 3, wherein each of the first memory and the second memory is configured to perform bidirectional data communication with the communication unit through the data bus.

9. The path providing device of claim 1, wherein the plurality of layers comprise at least one of a first layer including topology data, a second layer including advanced driver-assistance systems (ADAS) data, a third layer including high-density (HD) map data, or a fourth layer including the dynamic information.

10. The path providing device of claim 1, wherein the memory is further configured to store program instructions to be performed by the processor for determining or updating the optimal path.

11. A non-transitory memory device having stored thereon program instructions which, when executed by at least one processor, cause performance of operations for providing path information to a vehicle, the operations comprising:
receiving map information from a server, the map information comprising a plurality of layers of data;
receiving, through a communication unit, sensing information from one or more sensors disposed at the vehicle, the sensing information comprising an image received from an image sensor;
based on the sensing information, identifying a lane in which the vehicle is located among a plurality of lanes of a road,
determining an optimal path for guiding the vehicle from the identified lane, the optimal path comprising one or more lanes included in the map information,
based on the sensing information and the optimal path, generating autonomous driving visibility information to be transmitted to at least one of an electric component disposed at the vehicle or the server, and
updating the optimal path based on the autonomous driving visibility information and dynamic information related to a movable object located in the optimal path.

12. The non-transitory memory device of claim 11, comprising:
a plurality of memories configured to store information used for determining or updating the optimal path in different storage spaces based on types of information to be stored.

13. The non-transitory memory device of claim 12, wherein the plurality of memories comprise:
a first memory configured to store first data based on power being supplied to the non-transitory memory device; and
a second memory configured to retain second data while power is not supplied to the non-transitory memory device.

14. The non-transitory memory device of claim 13, wherein the first memory and the second memory are connected to a data bus, the data bus being configured to transmit the map information received through the communication unit to at least one of the first memory or the second memory.

15. The non-transitory memory device of claim 14, wherein the second memory has a first processing speed and a first storage capacity, and
wherein the data bus is connected to an external storage, the external storage having a second processing speed slower than the first processing speed and a second storage capacity greater than the first storage capacity.

16. The non-transitory memory device of claim 13, wherein the second memory is divided into a plurality of storage spaces that are configured to store different types of data, each of the plurality of storage spaces being configured to store one of the plurality of layers.

17. The non-transitory memory device of claim 16, wherein the plurality of storage spaces of the second memory comprise:
a first storage space configured to store a first type of data corresponding to a first layer among the plurality of layers; and
a second storage space configured to store a second type of data corresponding to a second layer among the plurality of layers, the second layer being different from the first layer.

18. The non-transitory memory device of claim 14, wherein the operations further comprise performing bidirectional data communication between the communication unit and each of the first memory and the second memory through the data bus.

19. The non-transitory memory device of claim 11, wherein the plurality of layers comprise at least one of a first layer including topology data, a second layer including advanced driver-assistance systems (ADAS) data, a third layer including high-density (HD) map data, or a fourth layer including the dynamic information.

20. The non-transitory memory device of claim 13, wherein the first memory comprises a random access memory (RAM), and the second memory comprises a flash memory device.
